(19) United States
(12) Patent Application Publication
(10) Pub. No.: US 2026/0161172 A1
(43) Pub. Date: Jun. 11, 2026

(54) USING NEURAL NETWORKS TO EXAMINE OBJECTS

(71) Applicant: Amazon Technologies, Inc., Seattle, WA (US)

(72) Inventors: Willem Hendrik Boshoff, Bristol (GB); Andrew Lee Allen, Stalybridge (GB); Joseph Benjamin Williams, Bristol (GB)

(21) Appl. No.: 18/976,964

(22) Filed: Dec. 11, 2024

(51) Int. Cl. G05D 1/639; B41J 3/407; G05D 1/249; G05D 101/15; G05D 105/00

(52) U.S. Cl. CPC G05D 1/642; B41J 3/4075; G05D 1/249; G05D 2101/15; G05D 2105/17

(57) ABSTRACT

Systems and methods are disclosed for examining objects (e.g., mobile storage units) using neural networks. Upon determining that the object is within an area of interest, the system uses multiple sensors positioned at various locations to capture the object from four or more sides at the same time. Using a neural network, the system identifies a first set of features of the object, which are then used to determine the location information of a second set of features, also identified by the neural network. The system evaluates whether this second set of features meets a series of criteria to determine if the object passes or fails the examination.

### BACKGROUND

In environments with storage containers and the many items (e.g., hundreds) they store, accurately identifying, monitoring, and tracking the storage containers and individual objects can be both time-consuming and error-prone. Visual inspections performed manually are subjective and may vary depending on the experience and training of the individual conducting them. Additionally, these inspections require a significant amount of time and effort, often leading to delays in identifying defects or quality issues. Challenges such as inconsistent lighting, shadows, reflections, and partial obstructions—where objects overlap or obscure one another—further increase the likelihood of missed defects or inaccuracies. Also, manual visual inspections can pose ergonomic risks to inspectors, particularly when repetitive tasks or awkward postures are required over extended periods, potentially leading to injuries. Accordingly, systems for identification, monitoring, tracking, and/or inspection can be improved.

### BRIEF DESCRIPTION OF THE DRAWINGS

Various techniques will be described with reference to the drawings, in which:

FIG. 1 illustrates an environment to examine objects within a station, according to at least one embodiment;

FIG. 2 illustrates an environment that includes a station and various types of objects, according to at least one embodiment;

FIG. 3 illustrates an environment that includes a station that prints results based on examination, according to at least one embodiment;

FIG. 4A illustrates a station that is foldable, according to at least one embodiment;

FIG. 4B illustrates a station that is folded, according to at least one embodiment;

FIG. 5 illustrates a system to train and deploy neural networks, according to at least one embodiment;

FIG. 6 illustrates a system to examine objects using neural networks, according to at least one embodiment;

FIG. 7 illustrates an interface that provides examination results, according to at least one embodiment;

FIG. 8 illustrates a process to examine objects, according to at least one embodiment; and

FIG. 9 illustrates a process to identify features of objects during examination, according to at least one embodiment;

FIG. 10 illustrates a process to perform corrective actions as a result of examination, according to at least one embodiment; and

FIG. 11 illustrates a system in which various embodiments can be implemented.

### DETAILED DESCRIPTION

Systems and methods are described herein for quality checks for objects (e.g., storage units such as pods) using computer vision and artificial intelligence (e.g., neural networks, machine learning). The systems may include a station that includes structure in a physical arrangement or layout configured to allow complete inspection of the objects in a single instance. In some instances, the stations can inspect hundreds of physical features of the objects inspected (e.g., determining whether the features are correctly installed or located) in a short period of time (e.g., within a couple minutes) using computer vision algorithms described herein.

The station may include sensors (e.g., cameras, distance sensors) positioned at various locations to capture the object within the station's area of interest. For example, a station may include four cantilevered sensors positioned at the top to capture objects within the station from all four sides within a single capture, along with two diagonal sensors at the bottom to detect lower features of the objects. Additionally, the station may include two sensors (e.g., barcode scanners) to capture an identifier (e.g., barcode) of the objects from various directions. For example, there can be at least four sensors that are placed around the object to capture its entire range of views without needing to move the object that is within the area. Each of at least four sensors can be dedicated to a specific side (e.g., front, back, left, right, top, bottom) to capture all angles concurrently. As another example, at least four sensors can surround the area of interest to capture a 360-degree view, allowing images to be captured at the same time.

The station may include additional sensors that are to capture a particular portion (e.g., bin) of the objects. Processors associated with the sensors may use a neural network (e.g., a convolutional neural network) to identify barcode or identifier locations within sensor data, along with a barcode decoder that may read and interpret these barcodes to retrieve or verify information based on the identified locations. The scanned portion can be used to receive information of the object. Some of the sensors within the station can generate sensor data useable to determine whether an object is located within the station's area of interest.

The systems can dynamically adjust (e.g., based on sensed light conditions) the intensity, frequency, temperature, or other properties of the light emitted by lighting elements attached to the station to enhance the quality of images captured by the sensors. For example, adjusted lighting conditions may reduce glare and improve visibility in low-light environments, resulting in clearer, more detailed images. In other examples, adjusted lighting conditions can balance light and shadow, bringing out finer details and resulting in sharper, more vibrant images. Also, controlled lighting may highlight different features of the objects that are within the station. The systems may use the lighting elements'positioning, as inputs to an algorithm or neural network to generate an adjustment (e.g., to adjust the light's intensity and/or frequency). The systems may can coordinate the light's intensity, frequency among lighting elements at the station such that they are synchronized for optimal performance.

The object can enter the station either via a conveyor belt installed beneath the station or by robots or any other drive units that transport the object into position. As the object enters the station, a self-contained computer system within the station can execute a range of computer vision tasks offline. This local setup can allow for all processing, computation, and model inference to happen directly on the device, removing the need for any internet connection. The local setup can make it suitable for secure, remote, or isolated environments where data privacy or network limitations are critical.

The computer system may receive sensor data from various sensors to determine if a robot has moved an object within a specified area. This computer system can identify objects using neural networks to identify and analyze features from different perspectives. The computer system may generate labels and confidence scores for these features, comparing them with a set of criteria or to assess compliance with a set of quality checks. Based on this analysis, the computer system can decide if the object passes or fails the examination and may suggest corrective actions (e.g., repairs) if issues arise out of the examination.

By determining the position of the camera, setting the appropriate angles, adjusting the lighting, and focusing on specific feature areas, the systems ensures that the software (e.g., neural networks) can effectively analyze the objects within area of interest while minimizing background noise. This setup can allow automatic tagging of features and uses neural networks to evaluate these tags with a quality control checklist. The station can examine objects with various types, each configurations, and may adapt to different physical constraints. For example, the station can examine G pods, H pods, J pods, HDTPs, etc. with distinct characteristics. The station can adjust to these variations through specific camera angles and neural network training. By automating the quality control process, the station can ensure that only compliant pods are put into service, while those with defects are flagged for rework, streamlining operations and enhancing accuracy.

Furthermore, the station may include a printing device for generating labels that provide operators with instructions (e.g., corrective actions) on reworking the objects. The labels may indicate which portions of the objects that needs to be reworked or what needs to be done to fix issues identified during the examination process. Additionally, the station may include a display that shows the examination process, such as the specific quality checks that each object has passed or failed. For example, the display could use green to indicate a pass and red to indicate a failure. The display may include a touchscreen interface, allowing operators to control the station. For example, the touchscreen interface may allow operators to print tickets that may include the labels or the instructions generated based on the examination results.

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

As one skilled in the art will appreciate in light of this disclosure including examination of objects using one or more neural networks to identify features within a station equipped with multiple cameras positioned at various locations and lighting elements to enhance object brightness, certain embodiments may be capable of achieving certain advantages, including some or all of the following: (1) automation of quality checks or any other examinations using neural networks, (2) increased inference speed (e.g., time per inference) by identifying reference points and locating the object in an exact location, (3) increased inference accuracy in performing quality checks or any other examinations by identifying reference points and locating the object in an exact location, (4) intuitive and effective user interfaces (e.g., display within stations), (5) advancing interoperability between devices (e.g., sensors, robots, display), etc.

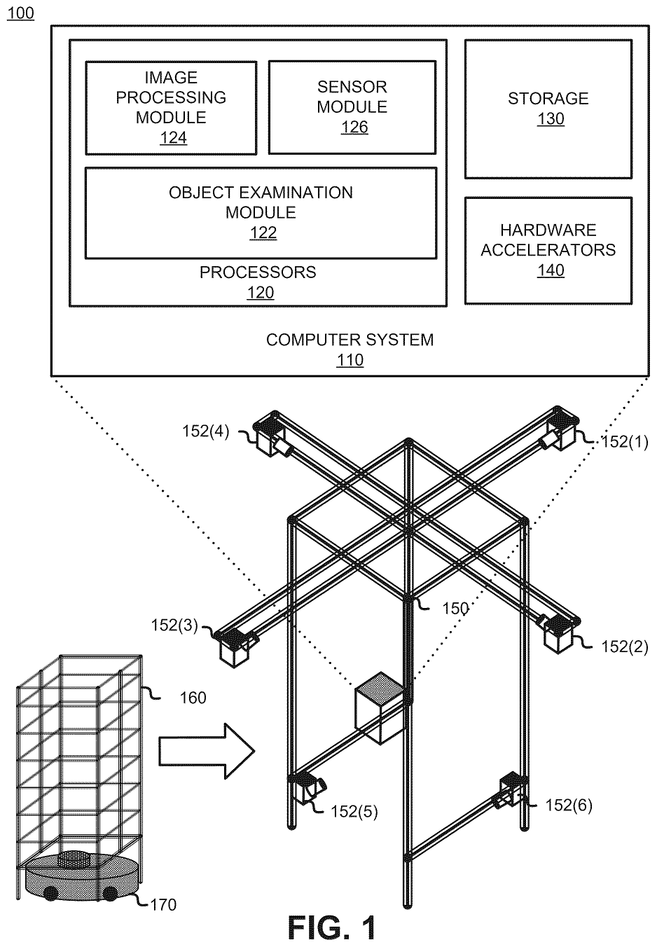

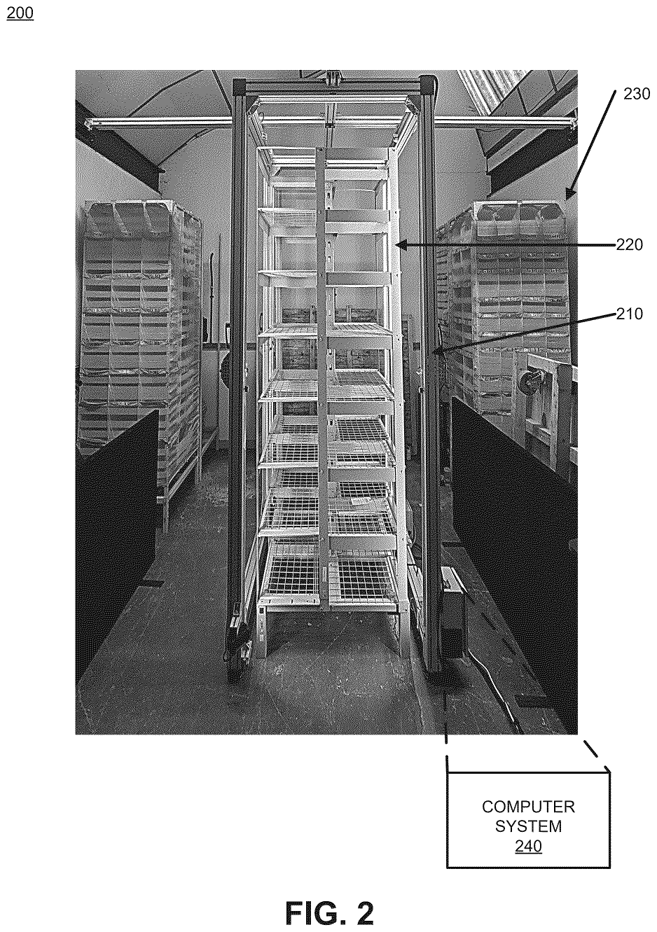

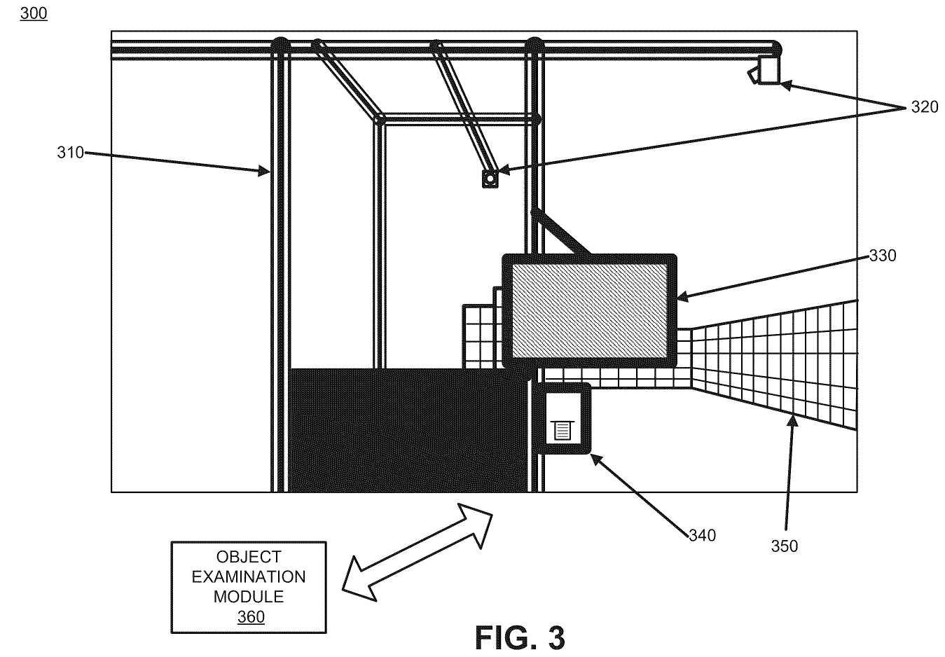

FIG. 1 illustrates environment 100 to examine objects within a station. Environment 100 may include computer system 110, station 150, object 160, and robot 170. Environment 100 may include environment 200 illustrated in FIG. 2. Environment 100 may include environment 300 illustrated in FIG. 3.

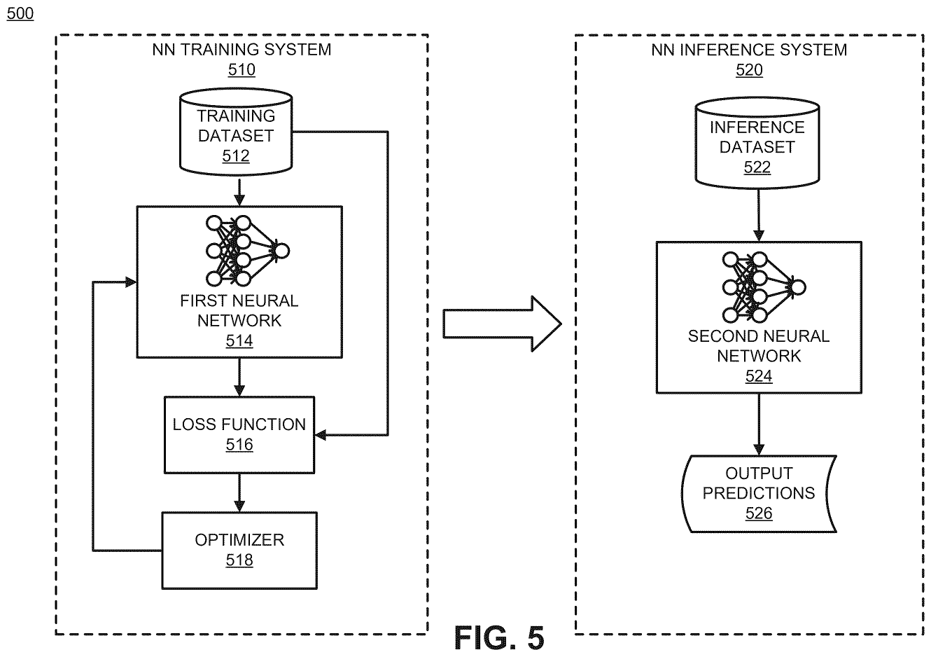

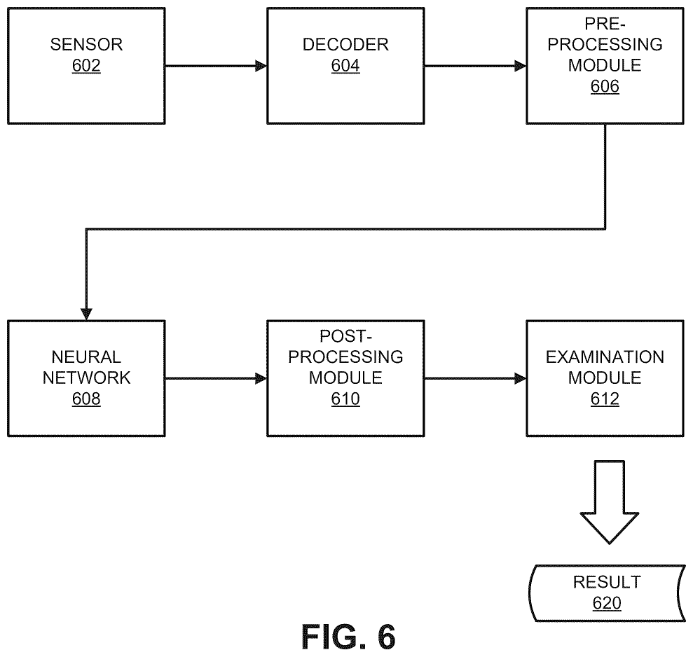

In at least one embodiment, computer system 110 may include one or more processors 120, storage 130, and one or more hardware accelerators 140. Computer system 110 may include system 500 illustrated in FIG. 5. Computer system 110 may include system 600 illustrated in FIG. 6. In at least one embodiment, computer system 110 can be an edge device physically integrated with station 150 to execute various functionalities (e.g., computer vision, artificial intelligence) as described herein. In some examples, computer system 110 may be cloud-based and connected through various types of network communication (e.g., wireless, wired, or cellular). In various examples, one or more components of environment 100 may be physically integrated with station 150, while other components may be cloud-based and connected via network communication. For example, sensor module 126 may be part of station 150, while other components of computer system 110 (e.g., image processing module 124, object examination module 122) can reside in the cloud. Computer system 110 may include computer system 240 illustrated in FIG. 2. In some examples, computer system 110 can be completely offline once it receives trained neural networks that perform various functionality described herein.

In at least one embodiment, one or more processors 120 may refer to one or more central processing units (CPU) or any other general-purpose processors. One or more processors 120 may include object examination module 122, image processing module 124, and sensor module 126. One or more processors 120 may run software to provide functionality described herein.

In at least one embodiment, terms such as “software” described herein may include one or more of the following: operating systems, device drivers, application software, database software, graphics software, web browsers, development software (e.g., integrated development environments, code editors, compilers, interpreters), network software, simulation software, real-time operating systems (RTOS), artificial intelligence software, robotics software, firmware (e.g., BIOS/UEFI, router, smartphone, consumer electronics, embedded systems, printer, solid state drive (SSD)), APIs, containerized software, container orchestration platforms, algorithms, instructions, and any other implementation embedded as a software package, code, and/or instruction set.

In at least one embodiment, terms such as “hardware” described herein may include one or more components of station 150, one or more processors 120, one or more hardware accelerators 140, and one or more sensors (e.g., sensor 152(1), sensor 152(2), sensor 152(3), sensor 152(4), sensor 152(5), sensor 152(6)). The “hardware” may further include hardwired circuitry, programmable circuitry, state machine circuitry, fixed function circuitry, execution unit circuitry, and/or firmware that stores instructions executed by programmable circuitry. As used in any implementation described herein, unless otherwise clear from context or stated explicitly to the contrary, terms such as “module” and nominalized verbs (e.g., object examination module 122, image processing module 124, sensor module 126, object examination module 360 illustrated in FIG. 3, decoder 604, pre-processing module 606, post-processing module 610, and examination module 612 illustrated in FIG. 6) illustrated in at least FIGS. 1, 3, and 6 each refer to any combination of software and/or hardware configured to provide specific functionality.

In at least one embodiment, object examination module 122 may refer to a module that examines objects (e.g., object 160, first object 220, second object 230 illustrated in FIG. 2, a plurality of objects 350 illustrated in FIG. 3) using neural networks (e.g., neural network 608 illustrated in FIG. 6). Object examination module 122 may include object examination module 360 illustrated in FIG. 3. In at least one embodiment, object examination module 122 may use one or more neural networks to perform one or more tasks (e.g., generating labels) to examine object 160.

In at least one embodiment, the one or more neural networks described throughout FIGS. 1-11 may refer to computational model comprising interconnected nodes (neurons) configured to process input data, identify patterns, and generate outputs based on learned relationships between the data. The one or more neural networks may include convolutional neural networks (CNNs), recurrent neural networks (RNNs), long short-term memory (LSTM) networks, generative adversarial networks (GANs), autoencoders, transformer networks (e.g., bidirectional encoder representations from transformers (BERT), generative pre-trained transformer (GPT), text-to-text transfer transformer (T5), vision transformers (ViT), XLNet), feedforward neural networks. The one or more neural networks may comprise one or more parameters (e.g., one or more weights, one or more biases).

In at least one embodiment, object examination module 122 may receive sensor data from any of sensors 152(1)-(6) to determine whether robot 170 moved object 160 in an area of interest within station 150. In some examples, being within station may include to object 160 being physically present in the defined spatial boundaries of the area of interest or station 150. This may also refer to object 160 being positioned inside station 150 in such a way that sensors 152(1)-(6) can effectively capture images of various components of object 160, ensuring that these components are in the same location or orientation within sensor data. Object 160 can be positioned within the area of interest so that specific features from different components of the object can serve as fixed reference points. This placement ensures accurate alignment and consistency for measurement, imaging, or processing tasks. Object examination module may identify, using any of sensors 152(1)-(6), one or more identifiers (e.g., barcodes) of object 160 to recognize the object. Upon determining that object 160 is within the area of interest, object examination module 122 uses sensor data (e.g., images) capturing object 160 from various perspectives to identify a first set of features (or regions) within the sensor data. Object examination module 122 may use neural networks described herein to identify the first set of features (or regions). Additionally, Object examination module 122 may use the neural networks to identify a second set of features (or regions) within the sensor data, which includes fasteners, connectors, or other common features among different objects. The second set of features can be reference points or fixed points to determine the coordinates, locations, or positions of the first set of features in 2D or 3D space. By using the coordinates, locations, or positions of the first set of features, object examination module 122 can generate labels and/or confidence scores that correspond to the first set of features.

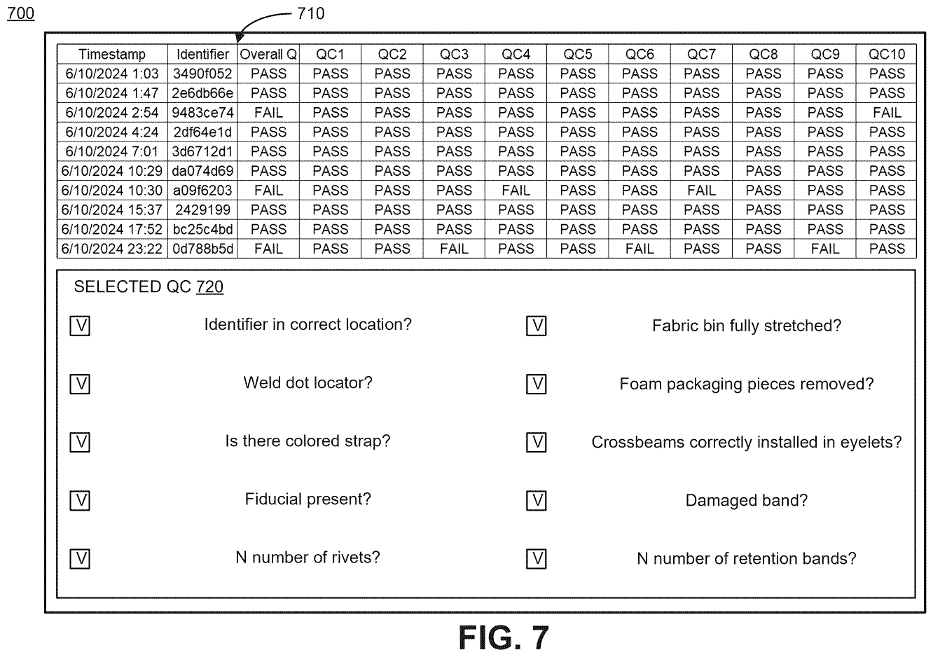

Consequently, object examination module 122 can compare those labels and/or confidence scores with a set of criteria (e.g., selected quality checks 720 illustrated in FIG. 7) to determine whether each of first set of features complied with the set of criteria. Object examination module 122 may determine whether object 160 passed or failed the examination based on how the first set of features comply with the set of criteria. The threshold for passing the examination can be based on a number of criteria that object 160 complied or certain types of criteria that object 160 complied. Object examination module 122 may generate labels or any other indications of success or failure as a result of the examination. Object examination module 122 may generate a list of corrective actions based on how the first set of features complied with the set of criteria. For example, object examination module 122 may generate a list of repairs for the object to meet the quality checks it initially failed to satisfy.

In at least one embodiment, sensors 152(1)-(6) can be located around object 160 to capture its full range of views without requiring any movement. Each of sensors 152(1)-(6) can be assigned to a different side of object 160 such that all sides (e.g., front, back, left, right, top, bottom) can be captured by sensors 152(1)-(6). This can allow for a complete set of images to be captured simultaneously and provide a thorough representation of object 160 without a need for rotation or repositioning. In some examples, sensors 152(1)-(6) may include additional sensors to capture specific points, such as the bottom left, top right, bottom front, and top back.

In at least one embodiment, image processing module 124 may refer to a module that that generates and preprocesses (e.g., denoises, downsamples, upsamples, or otherwise modifies) images usable by object examination module 122. Image processing module 124 may receive one or more images or frames from sensor module 126. Image processing module 124 may modify those images or frames. Modification of images may include, for example, resizing, cropping, normalization (e.g., scaling intensity values), augmentation (e.g., rotation, flipping, zooming, shifting, other affine transforms), redistribution of intensity values (e.g., histogram equalization), denoising, enhancement (e.g., increase brightness, contrast, sharpness), color space conversion, filtering (e.g., Laplacian, Sobel, Gaussian blur), image alignment, scaling (e.g., deep learning super-sampling (DLSS), Xe super-sampling (XeSS), AMD FidelityFX Super Resolution (FSR)), and/or anti-aliasing (e.g., multi-sample anti-aliasing (MSAA), fast approximate anti-aliasing (FXAA), temporal anti-aliasing (TAA), super-sampling anti-aliasing (SSAA), conservative morphological anti-aliasing (CMAA)).

In at least one embodiment, image processing module 124 may generate or modify neural network training data that can be used by image processing module 124. For example, image processing module 124 may generate labels for supervised learning or generate partially labeled data for semi-supervised learning of neural networks. Image processing module 124 may receive indications of ground truth to generate those labels. Image processing module 124 may increase the number of channels of image data by adding time series information to the image data. Image processing module 124 may transform information within one or more channels of image data (e.g., converting RGB data to time series data). In some examples, may generate training data for various types of objects, as described in conjunction with FIG. 2, enabling the neural networks used by the object examination module 122 to identify features across different object types.

In at least one embodiment, sensor module 126 may refer to a module that controls the one or more sensors (e.g., sensor 152(1)-(6)) and one or more lighting elements. The one or more sensors may refer to a device or component that detects, measures, and responds to physical, chemical, or environmental changes, such as temperature, pressure, motion, light, sound, or proximity, and converts this information into signals or data that can be interpreted by sensor module 126. The one or more sensors may may include cameras, color sensors, proximity sensors, distance sensors (e.g., Time of Flight sensor) LiDAR, etc. In some examples, sensors 152(1)-152(6) may include sensors 320 illustrated in FIG. 3. Sensors 152(1)-152(6) may include sensors 602 illustrated in FIG. 6. In some examples, sensor module 126 causes the one or more sensors to capture sensor data (e.g., images) at the same time.

In at least one embodiment, sensor module 126 may control the one or more sensors to receive sensor data, such as a set of images that include object 160 and robot 170, captured from different viewpoints using the one or more sensors positioned at various angles. The one or more sensors may provide a full 360-degree perspective of object 160 and robot 170 entering station 150.

In at least one embodiment, the one or more lighting elements may refer to components such as light panels, LED lights, flashlights, or ring lights that are attached to the one or more sensors to provide additional illumination. The one or more lighting elements can enhance image quality by improving lighting in low-light conditions, reducing shadows, and ensuring the subject is well-lit for clearer, sharper photos or videos.

In some examples, sensor module 126 may control lights emitted from one or more lighting elements (e.g., lighting strips, smart bulbs) attached to station 150 to improve the quality of sensor data captured by sensors 152(1)-152(6). Sensor module 126 can determine a frequency at which to emit light for station 150. Sensor module 126 can detect a specific wavelength of light (e.g., the color of the light, such as white) for station 150. Sensor module 126 controls the one or more lighting elements to increase brightness of station 150 above 100 lumens. Sensor module 126 can enhance the brightness of the one or more lighting elements to ensure that the sensors accurately capture the features of the object within station 150.

In at least one embodiment, storage 130 may refer to one or more hardware and software components described herein to store, retrieve, and manage data, allowing information to be saved and accessed by one or more entities (e.g., computer system 110, one or more processors 120, object examination module 122, image processing module 124, sensor module 126, storage 130, one or more hardware accelerators 140). The storage may include one or more of random access memory (RAM), read-only memory (ROM), flash memory (e.g., Universal Serial Bus (USB) flash drives, SSD, memory cards), cache memory, hard disk drives (HDDs), virtual memory, graphics memory, optical discs, network-attached storage (NAS), cloud storage, tape storage Additionally, the storage may further include one or more of relational databases, NoSQL databases, key-value stores, document-oriented databases, column-family stores, and graph databases. In addition, the storage may also include one or more of code repositories, artifact repositories, content repositories, document repositories, package repositories. Furthermore, the storage may include one or more of file storage (e.g., network-attached storage (NAS), cloud storage service), block storage, object storage, cache storage, tape storage, etc.

In some examples, storage 130 may store sensor data (e.g., set of images described herein) generated by sensors 152(1)-(6). Storage 130 may store modified sensor data (e.g., images with labels, tags) generated by object examination module 122. Storage 130 may store information (e.g., identifier) associated with station 150, the one or more sensors described herein, object 160, robot 170, etc. Storage 130 may store neural network training data (e.g., images with ground truth labels) to train one or more neural networks described herein. Storage 130 may include different groups of quality checks (e.g., selected quality checks 720 illustrated in FIG. 7) to examine object 160. Storage 130 may store data structures indicating examination results (e.g., whether object 160 passed the overall quality check or individual quality checks, a list of examination results 710 illustrated in FIG. 7). The data structures may include, for example, arrays, linked lists, stacks, queues, trees, hash tables, graphs, heaps, sets, etc.

In at least one embodiment, one or more hardware accelerators 140 may refer to one or more of specialized hardware units designed to perform specific tasks more efficiently than a general-purpose processor. Hardware accelerators include one or more of integrated circuit (IC), system on-chip (SoC), graphics processing unit (GPU), data processing unit (DPU), digital signal processor (DSP), tensor processing unit (TPU), accelerated processing unit (APU), application-specific integrated circuits (ASIC), intelligent processing unit (IPU), neural processing unit (NPU), smart network interface controller (SmartNIC), vision processing unit (VPU), field-programmable gate array (FPGA), etc.

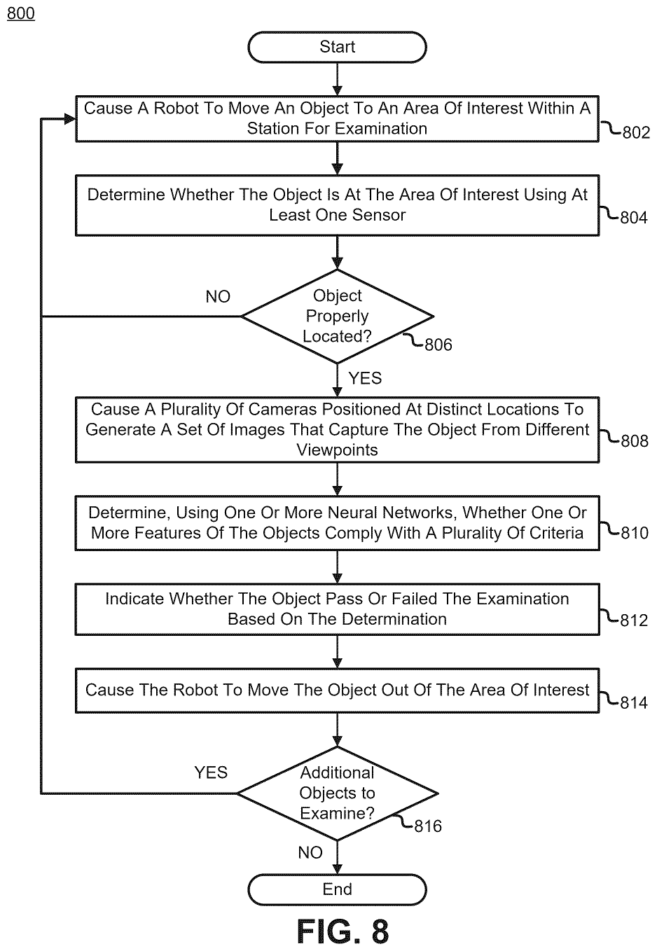

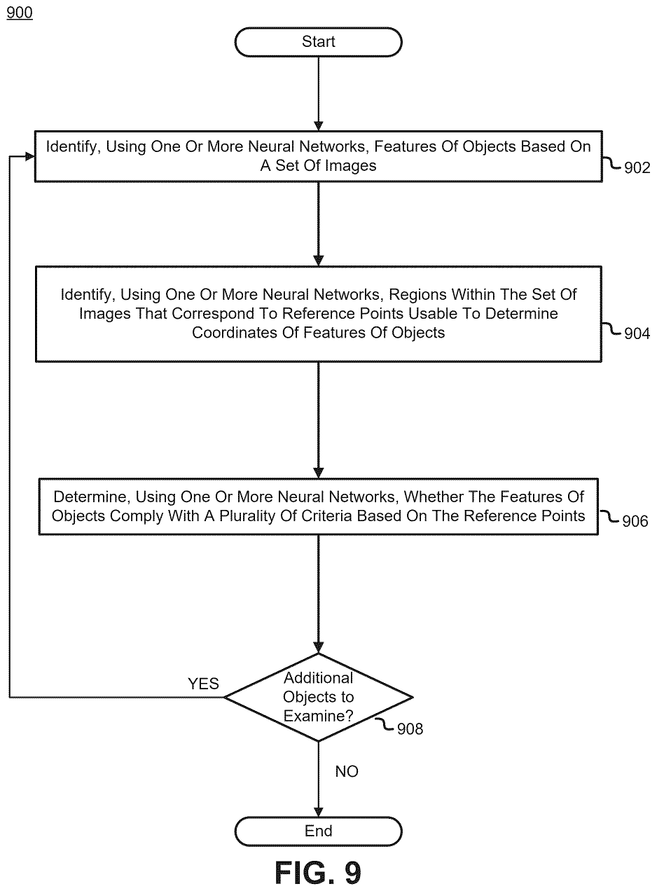

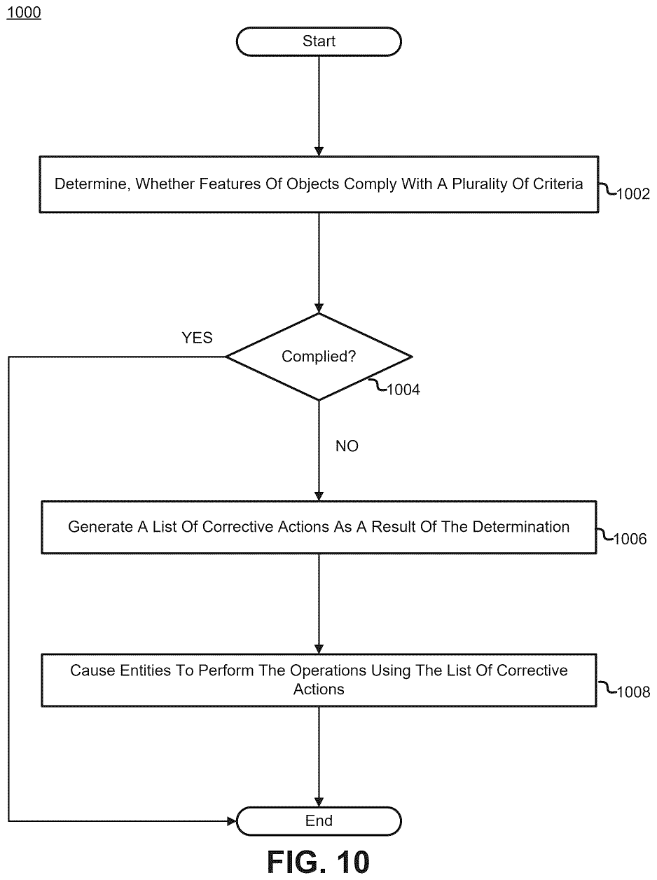

The specific tasks performed by one or more hardware accelerators 140 may include neural network inferencing and training described in conjunction with FIGS. 1, 5, and 6. Object examination module 122 use one or more hardware accelerators 140 for these tasks. For example, neural network inference for the tasks may include image classification, object detection, image segmentation (e.g., semantic segmentation, instance segmentation), image super-resolution, image synthesis and generation, style transfer) Additionally, one or more hardware accelerators 140 accelerate the performance of one or more blocks of process 800 illustrated in FIG. 8, process 900 illustrated in FIG. 9 and/or process 1000 illustrated in FIG. 10. One or more hardware accelerators 140 may accelerate one or more operations performed by station 150. Also, one or more hardware accelerators 140 may accelerate image generation and modification process performed by image processing module 124.

In at least one embodiment, station 150 may refer to a physical setup or configuration designed to allow different objects to be inspected at once. Station 150 may include four post aluminum frame with cantilevered arms. Station 150 may include one or more lighting elements such as ultra bright LED strips. Station 150 may include a touchscreen, allowing operators to manually control the examination process and display the results of object examinations for object 160.

In at least one embodiment, station 150 may include sensors 152(1)-152(6). Sensors 152(1)-152(4) can be located in upper corners of station 150 and Sensors 152(5)-152(6) can be located diagonally in the lower corners of station 150. In some examples, station 150 may include more than six sensors. In other examples, station 150 may include less than 6 six sensors.

In at least one embodiment, sensors 152(1)-152(6) may include one or more sensors to identify and process identifiers physically attached to object 160. The identifiers may include, holograms, watermarks, numeric codes, fingerprints, barcodes (e.g., universal product code (UPC), European article number (EAN), Code 39, Code 128, quick response (QR) code, data matrix, PDF417) etc. Barcodes may include, linear barcodes, two-dimensional barcodes, three-dimensional barcodes, color barcodes, etc. The one or more sensors may receive sensor data, such as images from any one of sensors 152(1)-152(6). Alternatively, the one or more identifier sensors may include one or more separate sensors that capture sensor data to identify and process the identifiers. Once one or more identifier sensors obtain or receive the sensor data, the one or more identifier sensors may send the sensor data one or more neural networks (e.g., CNN) to identify locations (e.g., coordinates) of the one or more identifiers within the sensor data. The one or more identifier sensors may include barcode decoders to obtain information of object 160 using the locations of the one or more identifiers within the sensor data. In some examples, the one or more identifier sensors may include laser barcode sensors that can scan the identifiers as robot 170 moves object 160 in a right location within station 150 without having to interpret sensor data from different sensors described herein. The one or more identifier sensors can be located in at least two of four bottom corners of station 150.

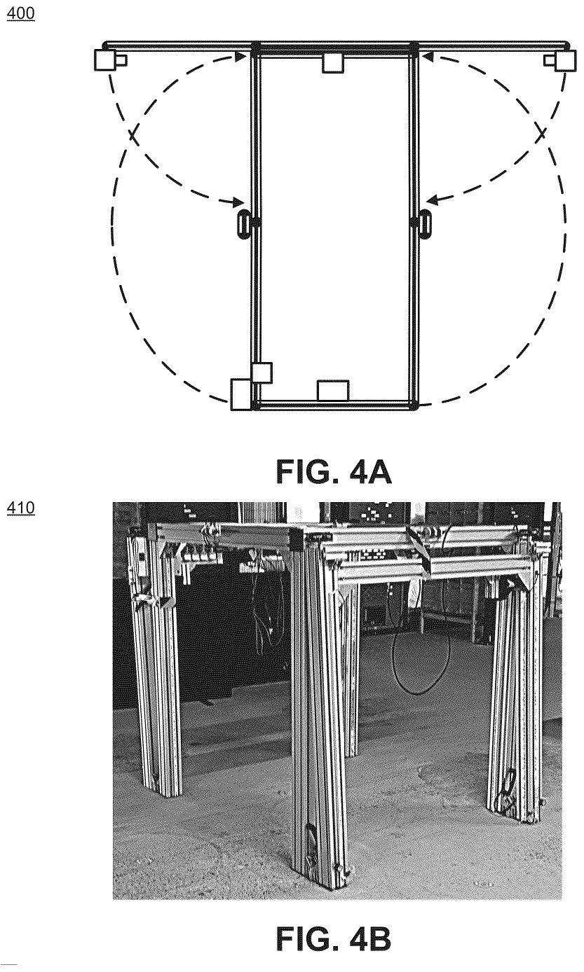

Station 150 may include station 210 illustrated in FIG. 2 Station 150 may include station 310 illustrated in FIG. 3. Station 150 may include station 400 illustrated in FIG. 4A. Station 150 may include 410 illustrated in FIG. 4B.

In at least one embodiment, object 160 may refer to storage units (e.g., pods) that hold inventory items for retrieval and transport. Object 160 may support shelves on all our sides. Object 160 may include a square base measuring approximately 1 meter by 1 meter (39 by 39 inches). Height of object 160 can range between 1.8 to 2.4 meters (6 to 8 feet). Constructed with a metal framework, object 160 may support shelves on all four sides, where the shelves can be made of hanging textile materials. Object 160 may include elastic straps that are secured across each shelf level. Object 160 may include a sturdy frame and multiple shelves or compartments for organizing products. Object 160 may include pods, containers, bins, carriers, crates, totes, boxes, cases, receptacles, etc. Standardized dimensions of object 160 may enable robots to interact with them seamlessly, ensuring efficient movement throughout the facility.

Each side of object 160 may include different sizes of bins. For example, the first and second faces of object 160 can include larger bins but a smaller number of them for larger items, while the third and fourth faces of object 160 can include smaller bins but a greater number of them for smaller items. In some examples, each face includes a tag that indicates the type (e.g., A, B, C, D) of the face. As a result, different items can be stored on each face of object 160.

Object 160 may include markers or fixtures that guide robot 170 how to lift and transport. Object 160 may include attachment points or slots that engage with the lifting platform of robot 170. Materials of object 160 may include durable metals or high-strength plastics to withstand frequent handling and movement. Object 160 may include sensors or identification tags, such as RFID tags or barcodes for tracking and/or identification of individual objects. In some examples, there can be two or more objects 160. The two or more objects 160 may include first object 220 and/or second object 230 illustrated in FIG. 2. The two or more objects 160 may include the plurality of objects 350 illustrated in FIG. 3.

In at least one embodiment, robot 170 may refer to mobile machines that operate independently without human intervention. Robot 170 may include sensors for environmental perception, processors for decision-making, and actuators for movement execution. Robot 170 may use sensor data from those sensors to perform decision-making to detect and avoid obstacles. Robot 170 may execute tasks by controlling motors and manipulators to move through environments and interact with objects (e.g., object 160). Robot 170 may include communication modules to perform data exchange with other systems (e.g., robot controller described herein, object examination module 122).

In at least one embodiment, robot 170 can be configured to transport object 160 across warehouse facilities. Robot 170 may navigate the warehouse floor using sensors and mapping algorithms to locate and move object 160 to designated locations (e.g., station 150). Robot 170 may navigate by following paths marked on the warehouse floor. Robot 170 can be instructed to avoid obstacles and ensure safe operation among human workers and other robots.

Robot 170 may pick up object 160 by positioning themselves beneath the pod and lifting it using an integrated lifting mechanism. The lifting mechanism may include a platform or lift that raises object 160 off the ground, allowing the robot to transport it to the required location. Robot 170 may maintain balance and stability during transport by continuously adjusting their movement based on sensor input.

In at least one embodiment, computer system 110 may further include or connected to a robot controller, which may refer to a module that directs the functions of robot 170. The robot controller receives sensor data a plurality of sensors (including sensor 152(1)-(6)) and processes this data to generate movement commands, manage obstacle avoidance, and adapt to dynamic conditions surrounding robot 170. The robot controller may include WiFi and Bluetooth for data exchange with robot 170 or the plurality of sensors.

The robot controller may use one or more algorithms to perform decision-making and path planning. For example, the one or more algorithms may include Simultaneous Localization and Mapping (SLAM), which allow robot 170 to construct a map of its environment while tracking its own position. The one or more algorithms may include A* search algorithm or Dijkstra's algorithm to calculate optimal routes. This can use the sensor data to detect obstacles and can include real-time adjustments to navigate around the obstacles.

The robot controller may use one or more neural networks such as CNNs to classify objects in the environment based on the sensor data. The robot controller may use the one or more neural networks such as RNNs or LSTMs to handle sequential data from sensors to generate real-time navigation decisions. The robot controller may use reinforcement learning algorithms that enable the robot to learn optimal paths through trial and error. The robot controller may include neural networks such as deep Q-networks (DQNs) and policy gradients to evaluate actions based on expected rewards.

The robot controller may coordinate with object examination module 122 and/or sensor module 126 to ensure that robot 170 carries object 160 to station 150. For example, object examination module 122 or the robot controller may determine that robot 170 placed object 160 at the right place by locating identifiers of object 160 and/or robot 170 using sensor data from sensor 152(5) and/or sensor 152(6). In some examples, object examination module 122 or the robot controller may use one or more neural networks, such as CNN to identify locations of identifiers within the sensor data. In various examples, object examination module 122 or the robot controller may use sensor data such as range data, 3D point clouds, and/or intensity values of returned laser signal to locate the exact location of object 160 and/or robot 170 within station 150 to determine whether examination of object 160 can be started as a result of object 160 being in the right location within station 150.

FIG. 2 illustrates environment 200 that may include station 220 and multiple objects (e.g., first object 220, second object 230), according to at least one embodiment. Environment 200 may refer to a controlled setting within a logistics or distribution facility where the objects including storage units, often called pods, are organized, transported, and processed for inventory management, picking, and packing operations Environment 200 may include environment 300 illustrated in FIG. 3. In at least one embodiment, station 210 may refer to a physical setup or configuration designed to perform automated quality check on objects to eliminate any defects. Station 210 may include station 150 illustrated in FIG. 1, station 310 illustrated in FIG. 3, station 400 illustrated in FIG. 4A, and/or station 410 illustrated in FIG. 4B.

In at least one embodiment, objects (e.g., first object 220, second object 230) may refer to mobile storage units used in conjunction with advanced robotic systems to optimize inventory management and order fulfillment. The objects can be our-sided shelving units designed to house a wide variety of products. The shelving can be arranged on all four sides, with compartments of varying sizes to accommodate products of different dimensions. Some objects may include hanging textile shelves for added flexibility and ease of access. Objects may further include automated guided vehicles (AGVs) with shelving, portable storage containers, storage shelves, tote picking cart, bin cart, bin organizer, storage cabinet, storage tower, storage rack, shelf bin organizer, stock cart, etc.

In at least one embodiment, different types of objects (e.g., first object 220, second object 230) may refer to storage units (e.g., pods) that vary in material composition and structural configuration to accommodate specific operational needs. These units may be constructed from materials such as metal, fabric, plastic, or hybrid combinations, each selected based on functional requirements. In some examples, those objects may include multi-shelf configurations, open frames, compartmentalized designs, collapsible components, etc.

In some examples, one or more entities, such as computer system 240 of station 210 can examine those objects (e.g., first object 220, second object 230) using neural networks trained with images of objects that vary in type, structure, or materials. These variations may influence the presence and placement of fasteners or connectors, which in turn affect the methodology used to determine if other features of the object meet specific criteria. Furthermore, additional features may serve as reference or fixed points for examination, depending on the object's type, structure, or materials. As new types of objects are manufactured, computer system 240 can further train or modify the neural network's architecture to accommodate these new types. In at least one embodiment, computer system 240 may include computer system 110 illustrated in FIG. 1, examination module 360 illustrated in FIG. 3, system 600 illustrated in FIG. 6 and perform one or more blocks of process 800 illustrated in FIG. 8, process 900 illustrated in FIG. 900, and/or process 1000 illustrated in FIG. 10 to perform examination of those objects.

FIG. 3 illustrates environment 300 that may include station 310 that prints results based on examination, according to at least one embodiment. Environment 300 may refer to controlled setting within a logistics or distribution facility where the objects including mobile storage units, often called pods, are organized, transported, and processed for inventory management, picking, and packing operations. Environment may include environment 200 illustrated in FIG. 2. Environment 300 may include station 310 and a plurality of objects 350.

In at least one embodiment, station 310 may refer to a physical setup or configuration designed to perform automated quality check on objects to eliminate any defects Station 310 may include station 150 illustrated in FIG. 1, station 210 illustrated in FIG. 2, station 400 illustrated in FIG. 4A, and/or station 410 illustrated in FIG. 4B. Station 310 may include two or more sensors 320, display 330, printing device 340, and examination module 360.

In at least one embodiment, two or more sensors 320 may refer to devices that captures and measures properties of light to generate visual or data outputs. Two or more sensors 320 may include sensors 152(1)-(6) illustrated in FIG. 1. Two or more sensors 320 may include the set of sensors 602 illustrated in FIG. 6. Two or more sensors 320 can provide a comprehensive view of each of the plurality of objects 350 when it enters station 310. Two or more sensors 320 can transmit data including the comprehensive view to examination module 360 for automatic examination. In at least one embodiment, a processor can cause two or more sensors 320 to capture images in parallel, eliminating the need to rotate or reposition objects to obtain a comprehensive view. The comprehensive view can include a view of an object from most sides (e.g., 4, 6, or 8 sides) or from most angles (e.g., 360 degrees, 270 degrees). For example, four cameras can capture images of a container storing items, where the images are generated simultaneously (e.g., in parallel), with each image showing a different side or section of the container such that the images can be combined to generate a comprehensive view of the object. By enabling two or more sensors 320 to capture images in parallel (e.g., simultaneously, at the same time), the images can be combined or used to provide the comprehensive view of an object (e.g., front, back, first side, second side, third side, fourth side) that can be used by the systems described herein. Also, images captured at specific times (e.g., same time) and specific locations (e.g., at 90 degrees from each other) enable neural networks to accurately correlate features, enhance object recognition, and improve reliability of spatial and temporal analyses.

In at least one embodiment, display 330 may refer to device that provides visual output of the automatic examination process performed by examination module 360. Display 330 may present real-time images or data collected from the plurality of objects 350 under scrutiny. display 330 may receive input from examination module 360 and/or two or more sensors 320 and translates it into visual formats, such as, tables, graphs, images, or numerical data. Display 330 can include an interactive screen (e.g., touchable display) that allows direct user interaction with station 310. Display 330 can include touch-sensitive sensors that detect user input, enabling the user to adjust settings, navigate through examination data, and control various functions of the inspection process. Display 330 may show to one or more operations physically present in a warehouse or any other environment, to check the progress of quality checks, as shown in interface 700 illustrated in FIG. 7.

In at least one embodiment, printing device 340 may refer to machine that transfers digital text and images onto physical media such as paper or plastic. Printing device 340 may include components like a print head, ink or toner cartridges, a paper feed system, and control circuitry that directs the printing operation. Printing device 340 may produce examination results of the plurality of objects 350 or labels of the plurality of objects 350 generated from examination module 360. Printing device 340 obtain the results or label information, processes the data to create a printable layout, and applies ink or toner to render the information onto media such as paper or adhesive labels. The paper or adhesive labels can be used to indicate a status (e.g., pass, fail) of each of the plurality of objects 350. The text may include one or more corrective actions, such as repairs, to address issues identified during the examination described herein.

In at least one embodiment, the plurality of objects 350 may refer to a group of modular storage units, where the units may include vertically arranged shelves or compartments for holding various items and may interact with robotic systems or human operators for inventory management. The plurality of objects 350 may include, pods, stationary storage racks, creates, totes, bins, containers, carts, shelving units, boxes, etc. The plurality of objects 350 may include object 160 illustrated in FIG. 1, and/or first object 220 and second object 230 illustrated in FIG. 2. In at some examples, at least one of the plurality of objects 350 is ready to be examined by station 310. In other examples, station 310 examines at least one of the plurality of objects 350.

In at least one embodiment, examination module 360 may refer to a module that examines objects such as the plurality of objects 350 or any other objects described throughout FIGS. 1-11. Examination module 360 may include object examination module 122 illustrated in FIG. 1 and/or system 600 illustrated in FIG. 6.

In at least one embodiment, after examination module 360 examines each of the plurality of objects 350 using one or more criteria (e.g., selected quality checks 720 illustrated in FIG. 7), examination module 360 may cause printing device 340 to generate labels that indicate examination results (e.g., success, failure). Also, the examination module 360 may cause printing device 340 to print information including one or more corrective actions to address one or more issues detected as a result of examining each of the plurality of objects 350. Additionally, examination module 360 may cause any of those information (e.g., examination results, corrective actions) to be displayed in display 330 to interact with associates working in environment 300. For example, examination module 360 may receive, through display 330, a selection of one or more criteria from a larger set of criteria that can be used to examine each of the multiple objects 350. To receive the selection, examination module 360 may cause display 330 to present a list derived from the larger set of criteria to enable the associates to make their selection. In some examples, examination module 360 can display a list of examination results (e.g., list of results 710) for the multiple objects 350 via display 330.

FIG. 4A illustrates station 400 that is foldable, according to at least one embodiment. Station 400 may refer to a physical arrangement or layout configured to allow the complete inspection the objects in a single instance. Station 400 may include station 150 illustrated in FIG. 1, station 210 illustrated in FIG. 2, station 310 illustrated in FIG. 3, and/or station 410 illustrated in FIG. 4B. In at least one embodiment, station 400 comprises a central frame structure with two vertical supports and a horizontal top rail. The frame can support various inspection components (e.g., sensors), enabling a comprehensive examination of objects placed within station 400. Station 400 may fold through a series of hinge connections and pivot points strategically located along the vertical supports and horizontal rail. These hinges may allow entities (e.g., associates, robots) to rotate the side sections inward, as indicated by the dashed arcs illustrated in FIG. 4A. The entities can engage locking joints to secure the station in both its operational and folded states. When in use, joints may keep the frame strong and stable. To fold the station, the entities may release the joints, allowing the side sections to collapse towards the center. In some examples, some systems (e.g., computer system 110) may automate the folding process, resulting in folded station 410 illustrated in FIG. 4B. FIG. 4B illustrates station 410 that is folded, according to at least one embodiment. Station 410 may refer to a physical arrangement or layout configured to allow the complete inspection the objects in a single instance. Station 410 may include station 150 illustrated in FIG. 1, station 210 illustrated in FIG. 2, station 310 illustrated in FIG. 3, and/or station 400 illustrated in FIG. 4A. The compact design of station 410 may allow the entities to store and transport it efficiently. Folding may reduce the overall footprint of the station, making it ideal for environments where space is limited or for applications requiring mobility.

FIG. 5 illustrates a system to train and deploy neural networks, according to at least one embodiment; FIG. 5 illustrates a system 500 to train and deploy neural networks to examiner objects, according to at least one embodiment. System 500 may include a distributed system may refer to a network of independent computers that coordinate to achieve common functionality (e.g., neural network training, neural network inferencing). System 500 may include nodes connected via communication protocols, data distribution methods, and synchronization mechanisms. The nodes may execute processes concurrently across different machines, exchanging messages and replicating data. System 500 may perform load balancing and fault detection operate to manage resources and ensure system reliability. Alternatively, system 500 may include a single computer or a server that manages and controls all operations.

In at least one embodiment, system 500 may include neural network training system 510 and neural network inference system 520. Neural network training system 510 may refer to one or more of software and hardware described in conjunction with FIG. 1 to train one or more neural networks described herein. Neural network training system 510 may include frameworks such as TensorFlow, PyTorch, Keras, MXNet, Caffe, Theano, etc. Neural network training system 510 may include using one or more hardware accelerators described herein (e.g., GPUs) to acclerator one or more portions to train neural network such as, first neural network 514. First neural network 514 may include the one or more neural networks described in conjunction with FIG. 5.

In at least one embodiment, neural network training system 510 may normalize and transform input data, such as training dataset 512. Neural network training system 510 may perform data normalization processes that scale feature values to a standard range, such as min-max scaling or z-score normalization. Neural network training system 510 may generate additional training samples to be added to training dataset 512 through transformations like rotation, flipping, or cropping. Neural network training system 510 may perform feature extraction operations, extracting relevant attributes from raw data, and feature selection, identifying the most significant features for first neural network 514. Neural network training system 510 may remove noise, address missing values, perform data cleaning tasks for training dataset 512.

In at least one embodiment, neural network training system 510 define the layers and connections of first neural network 514. Neural network training system 510 may determine the type of each layer, such as convolutional, recurrent, or fully connected layers, and set parameters like the number of neurons or filters. Neural network training system 510 may assign specific activation functions, such as ReLU or sigmoid, to each layer to introduce non-linearity. Neural network training system 510 may establishes connection patterns by configuring how layers interact, including sequential arrangements, skip connections, or branching paths. Neural network training system 510 may define inputs and output layers to ensure appropriate data flow through first neural network 514. Neural network training system 510 initialize weights and biases for each connection, setting initial values that influence the training process. In some examples, initializing of weights and biases may include (1) Zero Initialization, which sets all weights to zero; (2) random Initialization, where weights are set to small random values; (3) Glorot Initialization that adjusts the scale of the weights according to the number of input and output neurons; and (4) He Initialization that sets weights with a variance scaled by the number of input neurons.

In at least one embodiment, first neural network 514 may refer to the one or more neural networks described in conjunction with FIG. 1. In some examples, first neural network 514 may include a untrained neural network, which may refer to a neural network architecture that has been initialized but not yet exposed to any training data. In various examples, first neural network 514 may include pre-trained neural networks, such as VGG, ResNet, GoogleNet, EfficientNEt, YOLO, BERT, GPT, T5, RoBERTa, XLNet, DeepSpeech, Wav2Vec, Jasper, AlphaZero, StyleGAN, etc. In other examples, first neural network 514 may include second neural network 524 that is already trained.

In at least one embodiment, training dataset 512 may refer to a collection of labeled or unlabeled data used to train first neural network 514. Training dataset 512 may include input samples, which represent the features or attributes that the neural network processes, and corresponding target outputs, which first neural network 514 aims to predict. Training dataset 512 may include batches or mini-batches. Training dataset 512 may include various data formats, such as images, text, or numerical data, by structuring the data in formats compatible with the input layer of first neural network 514. Additionally, training dataset 512 may include metadata that provides information about the data sources, labeling schemes, and any preprocessing steps applied, as noted above. In some examples, there can be one or more neural networks (separate from first neural network 514) that generates training dataset 512. For example, the one or more neural networks may include Generative Adversarial Networks (GANs) or Variational Autoencoders (VAEs) that mimic the characteristics of a genuine dataset.

In at least one embodiment, neural network training system 510 performs forward pass using training dataset 512. The forward pass may refer to a process where input data from training dataset 512 propagates through first neural network 514 to generate output predictions. The forward pass may include feeding input samples into the input layer of first neural network 514, sequentially passing data through each hidden layer of first neural network 514 by applying the defined activation functions, and producing outputs in the output layer of first neural network 514. Neural network training system 510 may process each layer's computations by performing matrix multiplications with weights, adding biases, and applying activation functions to introduce non-linearity.

In at least one embodiment, neural network training system 510 uses loss function 516 to evaluate discrepancy between the output predictions and actual target values from training dataset 512 generated during the forward pass. Loss function 516 may include mechanisms for calculating the difference using specific mathematical formulations, such as mean squared error for regression tasks or cross-entropy loss for classification tasks. Loss function 516 can include aggregations of individual errors across the training samples to produce a single scalar value representing the overall performance of first neural network 514.

In at least one embodiment, optimizer 518 may refer to a computational component that adjusts weights and biases of first neural network 514 to minimize loss function 516. Optimizer 518 may include algorithms such as stochastic gradient descent (SGD), Adam, and RMSprop, each implementing specific strategies for updating parameters based on calculated gradients. Optimizer 518 may calculate gradients of loss function 516 with respect to each parameter by applying backpropagation, determining the direction and magnitude of adjustments needed. Optimizer 518 may manage learning rates, which control the step size of each update, and may incorporate techniques like momentum to accelerate convergence by considering past gradient information. Optimizer 518 may perform adaptive learning rate adjustments and allow different parameters to be updated at varying rates based on their individual gradient histories. Optimizer 518 may execute iterative update rules during each training epoch, systematically refining parameters of first neural network 514 to progressively reduce the loss and improve the performance of first neural network 514 on training dataset 512.

In at least one embodiment, neural network training system 510 may perform training in a supervised, partially supervised, or unsupervised manner. Neural network training system 510 may perform federated learning, where multiple decentralized devices or servers collaboratively train first neural network 514 while keeping the training data (e.g., portions of training dataset 512) localized.

In at least one embodiment, neural network training system 510 may perform fine tuning of of first neural network 514. Fine tuning may refer to performing additional training on a new, often more specific dataset to adapt its parameters for a particular task. Fine tuning may include loading the pre-trained weights and biases into the architecture of first neural network 514, selecting specific layers of first neural network 514 to update while freezing others to retain previously learned features. Fine tuning may include reinitializing certain layers of first neural network 514 if necessary and applying regularization techniques to prevent overfitting during the subsequent training phases. Fine tuning may include configuring a lower learning rate to make subtle adjustments to the parameters first neural network 514 of to ensure that the existing knowledge is preserved while accommodating new information.

In at least one embodiment, neural network training system 510 may perform the iterative process until first neural network 514 achieves a desired accuracy. For example, neural network training system 510 may evaluate first neural network 514 using a test or validation set and the accuracy can be the ratio of correctly predicted labels. In some examples, accuracy of first neural network 514 may depend on the final loss on the test or validation set. After determining that the desired accuracy is met, first neural network 514 becomes second neural network 524. In some examples, second neural network 524 may refer to one or more neural networks described in conjunction with FIG. 1.

In at least one embodiment, neural network inference system 520 may refer to a framework that executes trained neural network models, such as second neural network 524 to generate output predictions 526 based on new input data, such as inference dataset 522. Neural network inference system 520 may load and initialize parameters (e.g., weights, biases) of second neural network 524 into the runtime environment. Neural network inference system 520 feeds inference dataset 522 to input layer of second neural network 524, where values are generated and propagated through one or more layers of second neural network 524 and output predictions 526 are generated. In some examples, inference dataset 522 may include images, videos, text, audio, etc. inference dataset 522 may include synthetic data generated by neural networks (e.g., GAN) other than second neural network 524.

In at least one embodiment, neural network inference system 520 may include cloud servers or edge devices to deploy second neural network 524. Neural network inference system 520 may include cores, devices, inference chips, GPUs to generate activations to further generate output predictions 526. Output predictions 526 may include classification labels, probability distributions, continuous numerical values, sequences, images, translations, embeddings, actions, structured data outputs, audio, heatmaps, attention maps, generative content, etc.

FIG. 6 illustrates system 600 to examine objects using neural networks, according to at least one embodiment. System 600 may include a set of sensors 602, decoder 604, pre-processing module 606, neural network 608, post-processing module 610, and examination module 612. System 600 may refer to a video or image analytics pipeline.

In at least one embodiment, a set of sensors 602 may refer to devices that captures and measures properties of light to generate visual or data outputs (e.g., stream of images). One or more sensors 602 may include sensors 152(1)-(6) illustrated in FIG. 1. The set of sensors 602 may include two or more sensors 320 illustrated in FIG. 3. The set of sensors 602 can generate sensor data sensor data that includes a comprehensive view of an object (e.g., object 160 illustrated in FIG. 1, first object 220, second object 230 illustrated in FIG. 2, the plurality of objects 350 illustrated in FIG. 3) within a station (e.g., station 150 illustrated in FIG. 1, station 210 illustrated in FIG. 2, station 310 illustrated in FIG. 3, station 400 illustrated in FIG. 4A, station 410 illustrated in FIG. 4B) to other components of system 600 (e.g., decoder 604, pre-processing module 606, neural network 608, post-processing module 610, examination module 612) for automatic examination. For example, The set of sensors 602 can provide a 360 degree view of each of the plurality of objects 350 illustrated in FIG. 3 when it enters station 310 illustrated in FIG. 3.

In at least one embodiment, the set of sensors 602 can include four or more sensors arranged around the object to capture its entirety without rotation of the object or any of the set of sensors 602. Each of the set of sensors 602 can be located to focus on a different side of the object to obtain all perspectives at the same time. As a result, the set of sensors 602 can generate a stream of images that captures every angle and detail of the object in a single instance.

In at least one embodiment, decoder 604 may refer to a component in the video analytics pipeline that processes encoded the visual or data outputs and converting them into raw frames that can be analyzed further. In at least one embodiment, decoder 604 may perform the task of decoding compressed video formats, such as H.264, H.265, or MPEG, into uncompressed image data.

In at least one embodiment, pre-processing module 606 may refer to a module in the video analytics pipeline that modifies raw frames generated by decoder 604 by performing one or more operations needed to make the data compatible with neural network 608. The one or more operations may include resizing frames to certain dimensions, cropping areas of interest, normalizing pixel values to a defined scale, converting color formats, or adjusting frame layouts to match the input expectations of neural network 608. Pre-processing module 606 may perform any other operations to ensure that the raw frames match input expectations of neural network 608.

In at least one embodiment, neural network 608 may refer to a computational model composed of layers of interconnected nodes, where each node performs mathematical operations on input data using assigned weights and biases, and these layers work together to identify patterns, extract features, or make predictions based on the modified raw frames generated by pre-processing module 606.

In at least one embodiment, neural network 608 receives the modified raw frames that include the object. Neural network 608 can identify a first set of features for examination by examination module 612, as well as a second set of features that include connectors or fasteners (e.g., rivets). These connectors or fasteners can serve as reference points to determine the locations, positions, or coordinates of the features in 2D or 3D space. Neural network 608 may generate data that is used to create labels corresponding to both the first and second sets of features.

In at least one embodiment, post-processing module 610 may refer to a module in the video analytics pipeline that converts raw inference outputs, such as tensors, into meaningful results like object labels, coordinates, or associations that can be utilized by subsequent systems. In some examples, post-processing module 610 may perform tasks such as extracting classification labels, translating numerical outputs into bounding box positions on the frame, filtering objects based on confidence scores, matching detected objects across frames for tracking, and organizing this information into a specific metadata format. In other examples, post-processing module 610 may include neural networks separate from neural network 608. Post-processing module 610 may generate a plurality of labels and confidence scores that correspond to the first set of features of the object.

In at least one embodiment, examination module 612 may refer to a module that uses outputs generated by neural network 608 and post-processing module 610 to generate a final result 620 of the object. Examination module 612 may compare the first set of features identified by neural network 608, the plurality of labels and confidence scores generated by post-processing module 610 to identify whether each of the first set of features comply or not comply with a plurality of criteria (e.g., selected quality checks 720 illustrated in FIG. 7). In some examples, examination module 612 may receive indication of the plurality of criteria selected by an associate. Examination module 612 may generate results that indicate whether the object passed or failed examination or generate a list of examination results 710 illustrated in FIG. 7.

FIG. 7 illustrates an interface 700 that provides examination results, according to at least one embodiment. Interface 700 may include a list of examination results 710 and selected quality checks 720. In at least one embodiment, selected quality checks 720 may refer to a set of criteria chosen by a user or determined by an algorithm or logic, depending on the type of objects being examined. In some examples, users (e.g., associates within a fulfillment center) can select a subset of quality checks from a larger set available for one or more objects via a GUI. In addition to selected quality checks 720 illustrated in FIG. 7, additional criteria, such as quality checks may include:
Is the Pod ID label on the A-face of the pod base?
Is there a Weld Dot indicator on the A-Face of the pod base?
Is a coloured strap on the bottom of the A-face Fabric Bin Array?
Does the fabric bin array A-face align with the pod base A-face?
Is the Fabric Bin Array part number tag correctly sewn onto the designated location on the B face of the pod?
Is there a rivet present on the pod base and is it oriented correctly?
Is there an Arrow cut out on the bottom of the pod base and correctly aligned with the A-face of Pod?
Are all the clips connecting the fabric bin array to the crossbeams secured in place?
Are all Velcro straps on the top of the fabric bin array sandwiched around crossbeam and secured?
Are there 4 rivets per post, therefore 16 in total?
Have all foam packaging pieces been removed from the four corners of the pod base?
Is the Fabric Bin Array fully stretched and taught?
Are all corner uprights properly threaded through the top corner loops of the fabric bin array?
Are the crossbeams correctly installed in eyelets and fully hammered down?
Are all retentions bands installed horizontally, so that the retention bands do not overlap, and do not cross over the retentions bands?
Are there four total bands: two on the top most bin of the A-Face and C-Face?
Are both ends of the tops beams resting on the designated crossbeam rail?
Are retention bands woven through each bin divider on the woven band bin rows?
Does the number on retention bands per face match the count in the 700 level drawing?
Verify that there are no fabric defects, such as holes in fabric or torn fabric at the corners of the pod or excess fabric hanging off the sides.
Are any of the retention bands sagging?
Is the end of each Velcro retention band properly attached to the edge of the pod and aligned with the reference lines?
Are all 16 rivets marked with a sharpie/paint marker?
Tap the bottom of each bin on all faces of the pod. On the four faces, do all that bins have rigid bin liner?

In some examples, various systems (e.g., object examination module 122 illustrated in FIG. 1, computer system 240 illustrated in FIG. 2, examination module 360 illustrated in FIG. 3, system 600 illustrated in FIG. 6) can examine objects using selected quality checks 720 or any other criteria described herein to perform examination for each object that corresponds to an identifier. The identifiers can be linked to each quality check to produce the list of results 710. Each row in list of examination results 710 may include a timestamp indicating when the examination was completed, an identifier for the object, the examination results (e.g., passed, failed), and an indication of whether the object complied with each quality check.

FIG. 8 illustrates process 800 to examine objects, according to at least one embodiment. Although process 800 is depicted as a series of steps or operations, it will be appreciated that at least one embodiment of process 800 includes altered or reordered steps or operations, or omits certain steps or operations, except where explicitly noted or logically required, such as when an output of one step or operation is used as input for another. One or more entities described in conjunction with FIGS. 1-3 and 5-6, singly or in any combination, can perform each block of process 800. For example, the one or more entities may include computer system 110, one or more processors 120, object examination module 122, image processing module 124, sensor module 126, storage 130, one or more hardware accelerators 140, and sensors 152(1)-(6) illustrated in FIG. 1, computer system 240 illustrated in FIG. 2, examination module 360 illustrated in FIG. 3, neural network training system 510, neural network inference system 520, and second neural network 524 illustrated in FIG. 5, one or more sensors 602, decoder 604, pre-processing module 606, one or more neural networks 608, post-processing module 610, and examination module 612 illustrated in FIG. 6. The one or more entities may further include, for example, one or more of hardware and/or software described in conjunction with FIG. 1.

Various functions can be carried out by a processor executing instructions stored in memory (e.g., computer-readable, machine-readable) to perform process 800. For example, the instructions may include a computer program persistently stored on magnetic, optical, or flash media. Also, process 800 may be implemented as computer-usable instructions (e.g., macro instruction, micro-instruction) stored on computer storage media or provided by a standalone application, a service, or hosted service (standalone or in combination with another hosted service).

At block 802, the one or more entities may cause a robot (e.g., robot 170 illustrated in FIG. 1) to move an object (e.g., object 160 illustrated in FIG. 1, first object 220, second object 230 illustrated in FIG. 2, the plurality of objects 350 illustrated in FIG. 3) to an area of interest within a station (e.g., station 150 illustrated in FIG. 1, station 210 illustrated in FIG. 2, station 310 illustrated in FIG. 3, station 400 illustrated in FIG. 4A, station 410 illustrated in FIG. 4B) for examination.

At block 804, the one or more entities may determine whether the object is at the area of interest using at least one sensor (e.g., 152(5)-(6) illustrated in FIG. 1). The sensor may include camera or distance sensor (e.g., ToF sensor, LiDAR). In some examples, sensor data can be used to determine whether an identifier or any other feature of the object is positioned at a specific location, such as within an image. If the object is properly located within the area of interest at block 806, process 800 may move to block 808. If the object isn't properly located within the area of interest at block 806, process may move to block 802.

At block 808, the one or more entities may cause a plurality of cameras (e.g., sensors 152(1)-(6) illustrated in FIG. 1, sensors 320 illustrated in FIG. 3) positioned at distinct locations to generate a set of images that capture the object from different viewpoints. In at least one embodiment, the plurality of cameras (e.g., four or more cameras) can be positioned on four distinct sides surrounding the area of interest to allow each of the plurality of cameras to concurrently capture images of the object within the area of interest from its respective side. As a result, the one or more entities may monitor the object from all sides simultaneously by obtaining a complete set of perspectives.

At block 810, the one or more entities may determine, using one or more neural networks (e.g., second neural network 524 illustrated in FIG. 5, neural network 608 illustrated in FIG. 6), whether one or more features of the object comply with a plurality of criteria (e.g., selected quality checks 720 illustrated in FIG. 7). In some examples, block 810 may include block 902 and/or block 904 illustrated in FIG. 9. In other examples, block 810 may include block 1002 illustrated in FIG. 10.

At block 812, the one or more entities may indicate whether the object passes or fails the examination based on the determination done at block 810. In some examples, there is a threshold number of criteria that the object has to meet in order to pass the examination. In other examples, certain criteria, among others, may need to be met by the object to pass the examination.

At block 814, the one or more entities may cause the robot to move the object out of the area of interest. In some examples, the robot may move the object for deployment if the object pass the examination. In other examples, the robot may move the object such that corrective actions (e.g., repair) can be performed to address raised as a result of failing the examination.

At block 818, the one or more entities may determine whether there are additional objects to examine. Process 800 may return to block 802 to examine additional objects if any are present. If no additional objects are found, process 800 may conclude. In some embodiments, one or more of the operations performed in blocks 802, 804, 806, 808, 810, 812, 814, 816, and 818 can be performed in various orders and combinations, including in parallel.

FIG. 9 illustrates process 900 to identify features of objects during examination, according to at least one embodiment. Although process 900 is depicted as a series of steps or operations, it will be appreciated that at least one embodiment of process 900 includes altered or reordered steps or operations, or omits certain steps or operations, except where explicitly noted or logically required, such as when an output of one step or operation is used as input for another. One or more entities described in conjunction with FIGS. 1-3 and 5-6, singly or in any combination, can perform each block of process 900. For example, the one or more entities may include computer system 110, one or more processors 120, object examination module 122, image processing module 124, sensor module 126, storage 130, one or more hardware accelerators 140, and sensors 152(1)-(6) illustrated in FIG. 1, computer system 240 illustrated in FIG. 2, examination module 360 illustrated in FIG. 3, neural network training system 510, neural network inference system 520, and second neural network 524 illustrated in FIG. 5, one or more sensors 602, decoder 604, pre-processing module 606, one or more neural networks 608, post-processing module 610, and examination module 612 illustrated in FIG. 6. The one or more entities may further include, for example, one or more of hardware and/or software described in conjunction with FIG. 1.

Various functions can be carried out by a processor executing instructions stored in memory (e.g., computer-readable, machine-readable) to perform process 900. For example, the instructions may include a computer program persistently stored on magnetic, optical, or flash media. Also, process 900 may be implemented as computer-usable instructions (e.g., macro instruction, micro-instruction) stored on computer storage media or provided by a standalone application, a service, or hosted service (standalone or in combination with another hosted service).

At block 902, the one or more entities may identify, using one or more neural networks (e.g., second neural network 524 illustrated in FIG. 5, neural network 608 illustrated in FIG. 6), one or more features of objects (e.g., object 160 illustrated in FIG. 1, first object 220, second object 230 illustrated in FIG. 2, the plurality of objects 350 illustrated in FIG. 3) based on a set of images taken from various perspectives.

At block 904, the one or more entities may identify, using the one or more neural networks, regions within the set of images that correspond to reference points usable to determine coordinates of features of objects. The regions may include one or more fasteners or connectors (e.g., rivet, bolt, nut) that serves as reference points to describe the location of the one or more features in relation to it, using coordinates or measurements.

At block 906, the one or more entities may determine, using one or more neural networks, whether one or more features of the objects comply with a plurality of criteria (e.g., selected quality checks 720 illustrated in FIG. 7) based on the reference points. In some examples, block 906 may include block 1002 illustrated in FIG. 10.

At block 908, the one or more entities may determine whether there are additional objects to examine. Process 900 may return to block 902 to examine additional objects if any are present. If no additional objects are found, process 900 may conclude. In some embodiments, one or more of the operations performed in blocks 902, 904, 906, and 818 can be performed in various orders and combinations, including in parallel.

FIG. 10 illustrates process 1000 to perform corrective actions as a result of examination, according to at least one embodiment. Although process 900 is depicted as a series of steps or operations, it will be appreciated that at least one embodiment of process 900 includes altered or reordered steps or operations, or omits certain steps or operations, except where explicitly noted or logically required, such as when an output of one step or operation is used as input for another. One or more entities described in conjunction with FIGS. 1-3 and 5-6, singly or in any combination, can perform each block of process 900. For example, the one or more entities may include computer system 110, one or more processors 120, object examination module 122, image processing module 124, sensor module 126, storage 130, one or more hardware accelerators 140, and sensors 152(1)-(6) illustrated in FIG. 1, computer system 240 illustrated in FIG. 2, examination module 360 illustrated in FIG. 3, neural network training system 510, neural network inference system 520, and second neural network 524 illustrated in FIG. 5, one or more sensors 602, decoder 604, pre-processing module 606, one or more neural networks 608, post-processing module 610, and examination module 612 illustrated in FIG. 6. The one or more entities may further include, for example, one or more of hardware and/or software described in conjunction with FIG. 1.

Various functions can be carried out by a processor executing instructions stored in memory (e.g., computer-readable, machine-readable) to perform process 900. For example, the instructions may include a computer program persistently stored on magnetic, optical, or flash media. Also, process 900 may be implemented as computer-usable instructions (e.g., macro instruction, micro-instruction) stored on computer storage media or provided by a standalone application, a service, or hosted service (standalone or in combination with another hosted service).

At block 1002, the one or more entities may determine, using one or more neural networks (e.g., second neural network 524 illustrated in FIG. 5, neural network 608 illustrated in FIG. 6), whether one or more features of objects (e.g., object 160 illustrated in FIG. 1, first object 220, second object 230 illustrated in FIG. 2, the plurality of objects 350 illustrated in FIG. 3) comply with a plurality of criteria (e.g., selected quality checks 720 illustrated in FIG. 7) based on the reference points. In some examples, the one or more entities may identify fasteners, connectors or any other features of the object to serve as reference points. Process 1000 may proceed to block 1006 to If a number of criteria met exceeds the threshold at block 1004. If the number of criteria met exceeds the threshold at block 1004, process 1000 may conclude.

At block 1004, the one or more entities may generate a list of corrective actions as a result of the determination. The one or more entities may generate a list of corrective actions based on the criteria the objects failed to meet. may include procedures to repair or fix the object before deployment. The list of corrective actions may include which entity (e.g., human, robot) to perform the operations.

At block 1008, the one or more entities may cause other entities (e.g., human, robot) to perform the operations using the list of corrective actions. Once the other entities complete their operations, the objects may undergo further examination by executing one or more steps from process 800 illustrated in FIG. 8, and/or process 900 illustrated in FIG. 9. In some embodiments, one or more of the operations performed in blocks 1002, 1004, 1006, and 1008 may be performed in various orders and combinations, including in parallel.

Any system or apparatus feature described herein may also be provided as a method feature, and vice versa. System and/or apparatus aspects described functionally (including means-plus-function features) may be expressed alternatively in terms of their corresponding structure, such as a suitably programmed processor and associated memory. It should also be appreciated that particular combinations of the various features described and defined in any aspect of the present disclosure can be implemented, supplied, and used independently.

Any system or apparatus feature described herein can include computer programs and computer program products comprising software code adapted, when executed on a data processing apparatus, to perform any of the methods and/or embody any of the apparatus and system features described herein, including any or all of the component steps of any method. Any system or apparatus feature described herein can also include a computer or computing system (including networked or distributed systems) having an operating system that supports a computer program for carrying out any of the methods described herein and/or embodying any of the apparatus or system features described herein. Any system or apparatus feature described herein can also include computer-readable media having stored thereon any one or more of the computer programs aforesaid. Any system or apparatus feature described herein can include a signal carrying any one or more of the computer programs aforesaid.

Note that, in the context of describing disclosed embodiments, unless otherwise specified, the use of expressions regarding executable instructions (also referred to as code, applications, agents) performing operations that “instructions” do not ordinarily perform unaided (e.g., transmission of data, calculations) denotes that the instructions are being executed by a machine, thereby causing the machine to perform the specified operations.

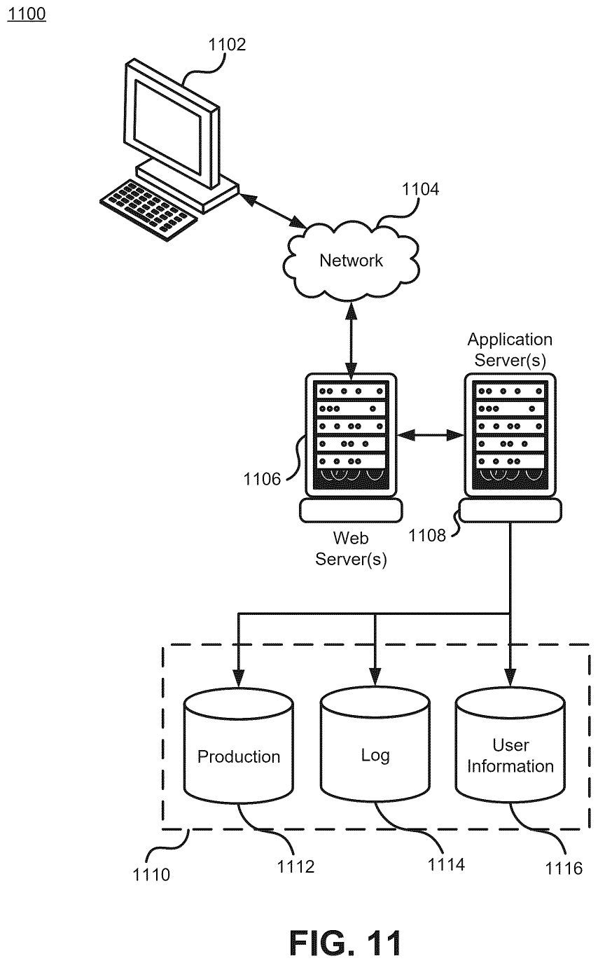

FIG. 11 illustrates aspects of an example system 1100 for implementing aspects in accordance with an embodiment. As will be appreciated, although a web-based system is used for purposes of explanation, different systems may be used, as appropriate, to implement various embodiments. In an embodiment, the system includes an electronic client device 1102, which includes any appropriate device operable to send and/or receive requests, messages, or information over an appropriate network 1104 and convey information back to a user of the device. Examples of such client devices include personal computers, cellular or other mobile phones, handheld messaging devices, laptop computers, tablet computers, set-top boxes, personal data assistants, embedded computer systems, electronic book readers, and the like. In an embodiment, the network includes any appropriate network, including an intranet, the Internet, a cellular network, a local area network, a satellite network or any other such network and/or combination thereof, and components used for such a system depend at least in part upon the type of network and/or system selected. Many protocols and components for communicating via such a network are well known and will not be discussed herein in detail. In an embodiment, communication over the network is enabled by wired and/or wireless connections and combinations thereof. In an embodiment, the network includes the Internet and/or other publicly addressable communications network, as the system includes a web server 1106 for receiving requests and serving content in response thereto, although for other networks an alternative device serving a similar purpose could be used as would be apparent to one of ordinary skill in the art.

In an embodiment, the illustrative system includes at least one application server 1108 and a data store 1110, and it should be understood that there can be several application servers, layers or other elements, processes or components, which may be chained or otherwise configured, which can interact to perform tasks such as obtaining data from an appropriate data store. Servers, in an embodiment, are implemented as hardware devices, virtual computer systems, programming modules being executed on a computer system, and/or other devices configured with hardware and/or software to receive and respond to communications (e.g., web service application programming interface (API) requests) over a network. As used herein, unless otherwise stated or clear from context, the term “data store” refers to any device or combination of devices capable of storing, accessing and retrieving data, which may include any combination and number of data servers, databases, data storage devices and data storage media, in any standard, distributed, virtual or clustered system. Data stores, in an embodiment, communicate with block-level and/or object-level interfaces. The application server can include any appropriate hardware, software and firmware for integrating with the data store as needed to execute aspects of one or more applications for the client device, handling some or all of the data access and business logic for an application.

In an embodiment, the application server provides access control services in cooperation with the data store and generates content including but not limited to text, graphics, audio, video and/or other content that is provided to a user associated with the client device by the web server in the form of HyperText Markup Language (“HTML”), Extensible Markup Language (“XML”), JavaScript, Cascading Style Sheets (“CSS”), JavaScript Object Notation (JSON), and/or another appropriate client-side or other structured language. Content transferred to a client device, in an embodiment, is processed by the client device to provide the content in one or more forms including but not limited to forms that are perceptible to the user audibly, visually and/or through other senses. The handling of all requests and responses, as well as the delivery of content between the client device 1102 and the application server 1108, in an embodiment, is handled by the web server using PHP: Hypertext Preprocessor (“PHP”), Python, Ruby, Perl, Java, HTML, XML, JSON, and/or another appropriate server-side structured language in this example. In an embodiment, operations described herein as being performed by a single device are performed collectively by multiple devices that form a distributed and/or virtual system.

The data store 1110, in an embodiment, includes several separate data tables, databases, data documents, dynamic data storage schemes and/or other data storage mechanisms and media for storing data relating to a particular aspect of the present disclosure. In an embodiment, the data store illustrated includes mechanisms for storing production data 1112 and user information 1116, which are used to serve content for the production side. The data store also is shown to include a mechanism for storing log data 1114, which is used, in an embodiment, for reporting, computing resource management, analysis or other such purposes. In an embodiment, other aspects such as page image information and access rights information (e.g., access control policies or other encodings of permissions) are stored in the data store in any of the above listed mechanisms as appropriate or in additional mechanisms in the data store 1110.

The data store 1110, in an embodiment, is operable, through logic associated therewith, to receive instructions from the application server 1108 and obtain, update or otherwise process data in response thereto, and the application server 1108 provides static, dynamic, or a combination of static and dynamic data in response to the received instructions. In an embodiment, dynamic data, such as data used in web logs (blogs), shopping applications, news services, and other such applications, are generated by server-side structured languages as described herein or are provided by a content management system (“CMS”) operating on or under the control of the application server. In an embodiment, a user, through a device operated by the user, submits a search request for a certain type of item. In this example, the data store accesses the user information to verify the identity of the user, accesses the catalog detail information to obtain information about items of that type, and returns the information to the user, such as in a results listing on a web page that the user views via a browser on the user device 1102. Continuing with this example, information for a particular item of interest is viewed in a dedicated page or window of the browser. It should be noted, however, that embodiments of the present disclosure are not necessarily limited to the context of web pages, but are more generally applicable to processing requests in general, where the requests are not necessarily requests for content. Example requests include requests to manage and/or interact with computing resources hosted by the system 1100 and/or another system, such as for launching, terminating, deleting, modifying, reading, and/or otherwise accessing such computing resources.

In an embodiment, each server typically includes an operating system that provides executable program instructions for the general administration and operation of that server and includes a computer-readable storage medium (e.g., a hard disk, random access memory, read only memory, etc.) storing instructions that, if executed by a processor of the server, cause or otherwise allow the server to perform its intended functions (e.g., the functions are performed as a result of one or more processors of the server executing instructions stored on a computer-readable storage medium).

The system 1100, in an embodiment, is a distributed and/or virtual computing system utilizing several computer systems and components that are interconnected via communication links (e.g., transmission control protocol (TCP) connections and/or transport layer security (TLS) or other cryptographically protected communication sessions), using one or more computer networks or direct connections. However, it will be appreciated by those of ordinary skill in the art that such a system could operate in a system having fewer or a greater number of components than are illustrated in FIG. 11. Thus, the depiction of the system 1100 in FIG. 11 should be taken as being illustrative in nature and not limiting to the scope of the disclosure.

The various embodiments further can be implemented in a wide variety of operating environments, which in some cases can include one or more user computers, computing devices or processing devices that can be used to operate any of a number of applications. In an embodiment, user or client devices include any of a number of computers, such as desktop, laptop or tablet computers running a standard operating system, as well as cellular (mobile), wireless and handheld devices running mobile software and capable of supporting a number of networking and messaging protocols, and such a system also includes a number of workstations running any of a variety of commercially available operating systems and other known applications for purposes such as development and database management. In an embodiment, these devices also include other electronic devices, such as dummy terminals, thin-clients, gaming systems and other devices capable of communicating via a network, and virtual devices such as virtual machines, hypervisors, software containers utilizing operating-system level virtualization and other virtual devices or non-virtual devices supporting virtualization capable of communicating via a network.

In an embodiment, a system utilizes at least one network that would be familiar to those skilled in the art for supporting communications using any of a variety of commercially available protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UpnP”), Network File System (“NFS”), Common Internet File System (“CIFS”) and other protocols. The network, in an embodiment, is a local area network, a wide-area network, a virtual private network, the Internet, an intranet, an extranet, a public switched telephone network, an infrared network, a wireless network, a satellite network, and any combination thereof. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the TCP protocol is a reliable connection-oriented protocol. Asynchronous Transfer Mode (“ATM”) and Frame Relay are unreliable connection-oriented protocols. Connection-oriented protocols are in contrast to packet-oriented protocols such as UDP that transmit packets without a guaranteed ordering.

In an embodiment, the system utilizes a web server that runs one or more of a variety of server or mid-tier applications, including Hypertext Transfer Protocol (“HTTP”) servers, FTP servers, Common Gateway Interface (“CGI”) servers, data servers, Java servers, Apache servers, and business application servers. In an embodiment, the one or more servers are also capable of executing programs or scripts in response to requests from user devices, such as by executing one or more web applications that are implemented as one or more scripts or programs written in any programming language, such as Java®, C, C #or C++, or any scripting language, such as Ruby, PHP, Perl, Python or TCL, as well as combinations thereof. In an embodiment, the one or more servers also include database servers, including without limitation those commercially available from Oracle®, Microsoft®, Sybase®, and IBM® as well as open-source servers such as MySQL, Postgres, SQLite, MongoDB, and any other server capable of storing, retrieving, and accessing structured or unstructured data. In an embodiment, a database server includes table-based servers, document-based servers, unstructured servers, relational servers, non-relational servers, or combinations of these and/or other database servers.

In an embodiment, the system includes a variety of data stores and other memory and storage media as discussed above that can reside in a variety of locations, such as on a storage medium local to (and/or resident in) one or more of the computers or remote from any or all of the computers across the network. In an embodiment, the information resides in a storage-area network (“SAN”) familiar to those skilled in the art and, similarly, any necessary files for performing the functions attributed to the computers, servers or other network devices are stored locally and/or remotely, as appropriate. In an embodiment where a system includes computerized devices, each such device can include hardware elements that are electrically coupled via a bus, the elements including, for example, at least one central processing unit (“CPU” or “processor”), at least one input device (e.g., a mouse, keyboard, controller, touch screen, or keypad), at least one output device (e.g., a display device, printer, or speaker), at least one storage device such as disk drives, optical storage devices, and solid-state storage devices such as random access memory (“RAM”) or read-only memory (“ROM”), as well as removable media devices, memory cards, flash cards, etc., and various combinations thereof.

In an embodiment, such a device also includes a computer-readable storage media reader, a communications device (e.g., a modem, a network card (wireless or wired), an infrared communication device, etc.), and working memory as described above where the computer-readable storage media reader is connected with, or configured to receive, a computer-readable storage medium, representing remote, local, fixed, and/or removable storage devices as well as storage media for temporarily and/or more permanently containing, storing, transmitting, and retrieving computer-readable information. In an embodiment, the system and various devices also typically include a number of software applications, modules, services, or other elements located within at least one working memory device, including an operating system and application programs, such as a client application or web browser. In an embodiment, customized hardware is used and/or particular elements are implemented in hardware, software (including portable software, such as applets), or both. In an embodiment, connections to other computing devices such as network input/output devices are employed.

In an embodiment, storage media and computer readable media for containing code, or portions of code, include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions, and equivalents falling within the spirit and scope of the invention, as defined in the appended claims.

At least one embodiment of the disclosure can be described in view of the following clauses:
1. A station, comprising:
a plurality of cameras positioned at distinct locations and oriented to generate different perspectives of an object;
one or more lighting elements to increase brightness of the object;
one or more processors; and
memory that stores computer-executable instructions that, if executed, cause the one or more processors to:
   determine that the object is positioned at a location within the station using at least one of the plurality of cameras;
   as a result of determining that the object is positioned at the station, use the plurality of cameras and one or more lighting elements to capture a set of images that include the object;
   identify, using one or more neural networks, a plurality of features of the object based, at least in part, on the set of images;
   identify, using one or more neural networks, a plurality of regions within the set of images that correspond to reference points to identify a plurality of coordinates of the plurality of features;
   determine whether the plurality of features of the object complied with a plurality of criteria based, at least in part, on the plurality of coordinates; and
   generate an indication on whether the object passed or failed an examination based, at least in part, on the determination.
2. The station of clause 1, further comprising: a display device that is to receive user input in response to presenting the indication or the plurality of criteria.
3. The station of clause 1 or 2, further comprising: a printing device that generates a ticket that indicates a set of corrective actions associated with an object to address one or more issues identified as a result of determining whether the plurality of features of the object complied with the plurality of criteria.
4. The station of any of clauses 1-3, wherein at least one of the plurality of cameras is used to detect one or more identifiers of the object, the one or more identifiers usable to store an association between the indication and the object.
5. A computer-implemented method, comprising:
in response to determining that an object is located within an area of interest, causing a plurality of sensors located in different locations to generate a set of images that simultaneously capture the object from at least four sides to provide different viewpoints;
identifying, using one or more neural networks, a first set of features of the object based, at least in part, on the set of images;
identifying, using the one or more neural networks, a second set of features of the object usable to determine one or more locations of the first set of features; and
determining whether the first set of features of the object complies with a set of criteria based, at least in part, on the one or more locations.
6. The method of clause 5, wherein the computer-implemented method further comprises:
causing one or more corrective actions to be performed to the object as a result of determining whether the first set of features of the object complies with the set of criteria.
7. The method of clause 5 or 6, wherein the computer-implemented method further comprises:
causing a robot to move the object out of the area of interest as a result of determining whether the second set of features of the object complies with a set of criteria.
8. The method of any of clauses 5-7, wherein the computer-implemented method further comprises:
indicating whether the object met or did not meet the set of criteria based, at least in part, on the determination of whether the second set of features of the object complied with a set of criteria.
9. The method of any of clauses 5-8, wherein the computer-implemented method further comprises:
generating, using a printing device, a set of instructions associated with an object to address one or more issues identified as a result of determining whether the second set of features of the object complies with a set of criteria.
10. The method of any of clauses 5-9, the computer-implemented method further comprises:
generating, using the one or more neural networks, a set of labels that correspond to the first set of features of the object, each of the set of labels is associated with a confidence level; and
determining whether the confidence level exceeds a threshold indicated by the set of criteria.
11. The method of any of clauses 5-10, wherein the computer-implemented method further comprises:
receiving an indication that the set of criteria is selected from two or more sets of criteria.
12. The method of any of clauses 5-11, wherein the first set of features of the object comprise a plurality of fasteners or connectors.
13. A non-transitory computer-readable storage medium storing thereon executable instructions that, as a result of being executed by one or more processors of a computer system, cause the computer system to at least:
determine that an object is located within a station by at least using at least one of a plurality of sensors;
cause the plurality of sensors placed at separate positions to concurrently generate a plurality of images capturing the object from four or more sides to obtain perspectives from multiple angles;
identify, using a neural network, one or more coordinates corresponding to a first set of regions within the plurality of images based, at least in part, on a second set of regions within the plurality of images, the first set of regions and the second set of regions corresponding to different features of the object; and
determine whether the object satisfies one or more criteria based, at least in part, on information generated using the one or more coordinates corresponding to the first set of regions.
14. The non-transitory computer-readable storage medium of clause 13, wherein the instructions further comprise instructions that, as a result of being executed by the one or more processors, cause the computer system to:
cause a printing device to print a label for the object, wherein the label is generated based, at least in part, on the determination of whether the object satisfies the one or more criteria.
15. The non-transitory computer-readable storage medium of clause 13 or 14, wherein the instructions further comprise instructions that, as a result of being executed by the one or more processors, cause the computer system to:
cause a user interface to display a set of criteria; and
receive, via the user interface, an indication that the one or more criteria is selected among the set of criteria.
16. The non-transitory computer-readable storage medium of any of clauses 13-15, wherein the at least one of plurality of sensors comprise one or more distance sensors.
17. The non-transitory computer-readable storage medium of any of clauses 13-16, wherein the instructions to determine whether the object satisfies the one or more criteria further comprise instructions that, as a result of being executed by the one or more processors, cause the computer system to:
generate, using the neural network, the set of labels that correspond to the first set of regions, each of the set of labels is associated with a confidence level; and
determine whether the confidence level exceeds a threshold indicated by the one or more criteria.
18. The non-transitory computer-readable storage medium of any of clauses 13-17, wherein the station comprises one or more connections to fold side sections of the station inward.
19. The non-transitory computer-readable storage medium of any of clauses 13-18, wherein one or more lighting elements increases brightness of the object when the plurality of images is generated by the at least two of the plurality of sensors.
20. The non-transitory computer-readable storage medium of any of clauses 13-19, wherein the instructions further comprise instructions that, as a result of being executed by the one or more processors, cause the computer system to:
cause a robot to move the object outside the station as a result of determining whether the object satisfies one or more criteria.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Similarly, use of the term “or” is to be construed to mean “and/or” unless contradicted explicitly or by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood within the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context. In addition, unless otherwise noted or contradicted by context, the term “plurality” indicates a state of being plural (e.g., “a plurality of items” indicates multiple items). The number of items in a plurality is at least two but can be more when so indicated either explicitly or by context.

Operations of processes described herein can be performed in any suitable order unless otherwise indicated herein or otherwise clearly contradicted by context. In an embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In an embodiment, the code is stored on a computer-readable storage medium, for example, in the form of a computer program comprising a plurality of instructions executable by one or more processors. In an embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In an embodiment, code (e.g., executable code or source code) is stored on a set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media, in an embodiment, comprises multiple non-transitory computer-readable storage media, and one or more of individual non-transitory storage media of the multiple non-transitory computer-readable storage media lack all of the code while the multiple non-transitory computer-readable storage media collectively store all of the code. In an embodiment, the executable instructions are executed such that different instructions are executed by different processors—for example, in an embodiment, a non-transitory computer-readable storage medium stores instructions and a main CPU executes some of the instructions while a graphics processor unit executes other instructions. In another embodiment, different components of a computer system have separate processors and different processors execute different subsets of the instructions.

Accordingly, in an embodiment, computer systems are configured to implement one or more services that singly or collectively perform operations of processes described herein, and such computer systems are configured with applicable hardware and/or software that enable the performance of the operations. Further, a computer system, in an embodiment of the present disclosure, is a single device and, in another embodiment, is a distributed computer system comprising multiple devices that operate differently such that the distributed computer system performs the operations described herein and such that a single device does not perform all operations.

The use of any and all examples or exemplary language (e.g., “such as”) provided herein is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references including publications, patent applications, and patents cited herein are hereby incorporated by reference to the same extent as if each reference were individually and specifically indicated to be incorporated by reference and were set forth in its entirety herein.

What is claimed is:

1. A station, comprising:
a plurality of cameras positioned at distinct locations and oriented to generate different perspectives of an object;
one or more lighting elements to increase brightness of the object;
one or more processors; and
memory that stores computer-executable instructions that, if executed, cause the one or more processors to:
determine that the object is positioned at a location within the station using at least one of the plurality of cameras;
as a result of determining that the object is positioned at the station, use the plurality of cameras and one or more lighting elements to capture a set of images that include the object;
identify, using one or more neural networks, a plurality of features of the object based, at least in part, on the set of images;
identify, using one or more neural networks, a plurality of regions within the set of images that correspond to reference points to identify a plurality of coordinates of the plurality of features;
determine whether the plurality of features of the object complied with a plurality of criteria based, at least in part, on the plurality of coordinates; and
generate an indication on whether the object passed or failed an examination based, at least in part, on the determination.

2. The station of claim 1, further comprising: a display device that is to receive user input in response to presenting the indication or the plurality of criteria.

3. The station of claim 1, further comprising: a printing device that generates a ticket that indicates a set of corrective actions associated with an object to address one or more issues identified as a result of determining whether the plurality of features of the object complied with the plurality of criteria.

4. The station of claim 1, wherein at least one of the plurality of cameras is used to detect one or more identifiers of the object, the one or more identifiers usable to store an association between the indication and the object.

5. A computer-implemented method, comprising:
in response to determining that an object is located within an area of interest, causing a plurality of sensors located in different locations to generate a set of images that simultaneously capture the object from at least four sides to provide different viewpoints;
identifying, using one or more neural networks, a first set of features of the object based, at least in part, on the set of images;
identifying, using the one or more neural networks, a second set of features of the object usable to determine one or more locations of the first set of features; and
determining whether the first set of features of the object complies with a set of criteria based, at least in part, on the one or more locations.

6. The method of claim 5, wherein the computer-implemented method further comprises:
causing one or more corrective actions to be performed to the object as a result of determining whether the first set of features of the object complies with the set of criteria.

7. The method of claim 5, wherein the computer-implemented method further comprises:
causing a robot to move the object out of the area of interest as a result of determining whether the second set of features of the object complies with a set of criteria.

8. The method of claim 5, wherein the computer-implemented method further comprises:
indicating whether the object met or did not meet the set of criteria based, at least in part, on the determination of whether the second set of features of the object complied with a set of criteria.

9. The method of claim 5, wherein the computer-implemented method further comprises:
generating, using a printing device, a set of instructions associated with an object to address one or more issues identified as a result of determining whether the second set of features of the object complies with a set of criteria.

10. The method of claim 5, the computer-implemented method further comprises:
generating, using the one or more neural networks, a set of labels that correspond to the first set of features of the object, each of the set of labels is associated with a confidence level; and
determining whether the confidence level exceeds a threshold indicated by the set of criteria.

11. The method of claim 5, wherein the computer-implemented method further comprises:
receiving an indication that the set of criteria is selected from two or more sets of criteria.

12. The method of claim 5, wherein the first set of features of the object comprise a plurality of fasteners or connectors.

13. A non-transitory computer-readable storage medium storing thereon executable instructions that, as a result of being executed by one or more processors of a computer system, cause the computer system to at least:
determine that an object is located within a station by at least using at least one of a plurality of sensors;
cause the plurality of sensors placed at separate positions to concurrently generate a plurality of images capturing the object from four or more sides to obtain perspectives from multiple angles;
identify, using a neural network, one or more coordinates corresponding to a first set of regions within the plurality of images based, at least in part, on a second set of regions within the plurality of images, the first set of regions and the second set of regions corresponding to different features of the object; and
determine whether the object satisfies one or more criteria based, at least in part, on information generated using the one or more coordinates corresponding to the first set of regions.

14. The non-transitory computer-readable storage medium of claim 13, wherein the instructions further comprise instructions that, as a result of being executed by the one or more processors, cause the computer system to:
cause a printing device to print a label for the object, wherein the label is generated based, at least in part, on the determination of whether the object satisfies the one or more criteria.

15. The non-transitory computer-readable storage medium of claim 13, wherein the instructions further comprise instructions that, as a result of being executed by the one or more processors, cause the computer system to:
cause a user interface to display a set of criteria; and
receive, via the user interface, an indication that the one or more criteria is selected among the set of criteria.

16. The non-transitory computer-readable storage medium of claim 13, wherein the at least one of plurality of sensors comprise one or more distance sensors.

17. The non-transitory computer-readable storage medium of claim 13, wherein the instructions to determine whether the object satisfies the one or more criteria further comprise instructions that, as a result of being executed by the one or more processors, cause the computer system to:
generate, using the neural network, the set of labels that correspond to the first set of regions, each of the set of labels is associated with a confidence level; and
determine whether the confidence level exceeds a threshold indicated by the one or more criteria.

18. The non-transitory computer-readable storage medium of claim 13, wherein the station comprises one or more connections to fold side sections of the station inward.

19. The non-transitory computer-readable storage medium of claim 13, wherein one or more lighting elements increases brightness of the object when the plurality of images is generated by the at least two of the plurality of sensors.

20. The non-transitory computer-readable storage medium of claim 13, wherein the instructions further comprise instructions that, as a result of being executed by the one or more processors, cause the computer system to:
cause a robot to move the object outside the station as a result of determining whether the object satisfies one or more criteria.
